(19) United States
(12) Patent Application Publication
(10) Pub. No.: US 2026/0301106 A1
(43) Pub. Date: Oct. 1, 2026

(54) GRAPHICS PROCESSING SYSTEMS

(71) Applicant: Arm Limited, Cambridge (GB)

(72) Inventors: Frank Klaeboe Langtind, Melhus (NO); Ashutosh Pattnaik, Austin, TX (US)

(73) Assignee: Arm Limited, Cambridge (GB)

(21) Appl. No.: 19/090,447

(22) Filed: Mar. 26, 2025

(51) Int. Cl. G06T 1/20

(52) U.S. Cl. CPC G06T 1/20

(57) ABSTRACT

A graphics processor is operable to execute a processing pipeline in which a same pipeline stage is operable to invoke multiple different shader programs, with the shader program being invoked for a particular set of work being determined and specified for the set of work itself. In this way, the processing pipeline can support so-called “work graph” programming models.

### BACKGROUND

The technology described herein relates to graphics processing, and graphics processors, and in particular to the operation and configuration of a graphics processor that is operable to support various processing flows.

Graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles.

Each primitive is usually defined by and represented as a set of vertices, where each vertex typically has associated with it a set of “attributes”, i.e. a set of data values for the vertex. These attributes will typically include position data and other, non-position data (varyings), e.g. defining colour, light, normal, texture coordinates, etc, for the vertex in question.

For a given output, e.g. frame to be displayed, to be generated by the graphics processing system, there will typically be a set of vertices defined for the output in question. The primitives to be processed for the output will then be indicated as comprising given vertices in the set of vertices for the graphics processing output being generated. Typically, the overall output, e.g. frame to be generated, will be divided into smaller units of processing, referred to as “draw calls”. Each draw call will have a respective set of vertices defined for it and a set of primitives that use those vertices.

Once primitives and their vertices have been generated and defined, they can be processed by the graphics processing system, in order to generate the desired graphics processing output (render target), such as a frame for display. This basically involves rendering the primitives to generate the graphics processing output.

The rendering process uses the vertex attributes associated with the vertices of the primitives that are being processed. To facilitate this operation, the vertices defined for the given graphics processing output (e.g. draw call) are usually subjected to an initial so-called “vertex shading” operation, before the primitives are rendered.

The vertex shading operation typically produces (transformed) vertex positions and one or more outputs explicitly written by the vertex shader. (Attributes output from the vertex shader other than position are usually referred to as “varyings”.)

A graphics processing pipeline will typically therefore include one or more vertex shading stages (vertex shader(s)) that execute vertex shading operations, e.g. using the initial vertex attribute values defined for the vertices (and otherwise), so as to generate a desired set of output vertex attributes (i.e. appropriately “shaded” attributes) for use in subsequent pipeline stages of the graphics processing pipeline.

Once the vertex attributes have been shaded, the “shaded” attributes are then used when processing the vertices (and the primitives to which they relate) in the remainder of the graphics processing pipeline.

For example, the “vertex shaded” vertex positions and varyings may be used when rendering the primitives to provide the render output, for example when performing rasterization and/or fragment shading operations. In the case of a tile-based graphics processing pipeline (where the two-dimensional render output (target) is rendered as a plurality of smaller area sub-regions, usually referred to as “tiles”), the vertex shaded (transformed) positions may be used to sort the primitives relative to the rendering tiles and/or to derive data structures for allowing the primitives to be sorted relative to the rendering tiles.

A vertex shading operation in a graphics processing pipeline will, accordingly, process one or more and typically a plurality of vertices (which can correspondingly be considered to be respective “work items” for the shading operation), to produce a respective “vertex shaded” attribute or attributes for each vertex (work item) that is processed (which attribute or attributes can correspondingly be considered to be respective data elements for the vertex (work item) in question).

Graphics processing pipelines can also include various other (shading) stages that process respective work items and generate a respective data element or elements for each of the work items that they process.

For example, in more advanced geometry processing flows, e.g., where tessellation is enabled, the vertex shading stages described above may be followed by one or more tessellation stages, which tessellation stages typically include a tessellation control shader (TCS) stage (e.g. that determines an amount of tessellation to perform), a tessellation stage that performs the desired tessellation operations (e.g. by executing a tessellation shader and/or using a (fixed-function) tessellation hardware circuit), and a tessellation evaluation shader (TES) (that applies interpolation or other post-processing operations on the tessellated output). More advanced graphics processing flows may also include other stages that perform vertex post-processing such as, but not limited to, a transform feedback stage that captures primitives generated by the vertex processing.

As another example, rather than performing vertex processing (shading) in the manner described above, a graphics processing pipeline may be configured to implement so-called “task” and “mesh” shading stages (shaders). Compared to traditional vertex shading operations, wherein a vertex shader may simply load in a certain number of vertices and then process (i.e. shade) them, a mesh shading stage (mesh shader) is operable to create its own output vertices and primitives.

For instance, a task shading stage (task shader) (also sometimes referred to as an “amplification” shader) can be executed to determine how many child mesh shader workgroups should be launched in a subsequent mesh shading stage (mesh shader). Each mesh shader workgroup can then produce a respective set of output vertices and primitives (i.e. a “meshlet”) with all mesh shader workgroups together creating the full output mesh (and so mesh shaders may perform “compute” shader-like processing in which mesh shader workgroups cooperatively generate meshes).

A task shader may also optionally output a payload that is passed to any of its child mesh shader workgroups.

The use of such “task” and “mesh” shaders can at least in some cases thus provide greater flexibility for the application programmer, e.g. compared to graphics processing pipelines that implement more traditional vertex shading operations, as the inputs to and outputs from the “task” and “mesh” shaders can be customised.

Thus, a graphics processor may execute a graphics processing pipeline to support a desired graphics processing flow, and the graphics processor (hardware) may accordingly be configured to support the particular graphics processing pipeline that is desired to be executed by the graphics processor. In this regard, it would be possible to execute any desired graphics processing pipeline entirely in software, e.g. using general purpose compute shader operations. However, this is not normally efficient, and so some level of hardware support is often provided for the graphics processing pipeline, with the pipeline stages typically being specialised to perform certain processing operations for executing a particular graphics processing pipeline.

Another approach, potentially providing the application programmer with even greater flexibility, is the use of “work graph” programming models.

As described in the Direct3D 12 API, a work graph is a collection of “nodes”, with the nodes being connected along graph edges to represent possible data flow paths through the work graph, and each node being operable to perform a particular instance of processing. Thus, a given node may thus receive one or more input “records” identifying data to be processed by that node, and will then process this data to produce corresponding output “records”, which may then be passed as input records to a next node of the work graph for further processing.

The particular processing that a given node performs is however flexible. For example, and typically, respective nodes of the work graph will invoke respective compute shaders, but the application programmer is able to flexibly define which shaders are invoked by which nodes. Further, the processing that is performed by a given node to produce an output record may also determine to which next node the output record should be passed for further processing (which next node may, e.g., and typically will, be a ‘child’ node of the current node, but could also be the current node, as work graph programming models permit self-recursion (although are otherwise acyclic)).

The work graph programming model thus allows compute shaders to launch other compute shaders directly on the graphics processor. This can in turn facilitate the graphics processor to drive its own processing work, such that the data flow can be determined by the graphics processor itself in use.

Thus, a work graph may be executed to perform some or all of the desired geometry processing operations for a particular graphics processing pipeline, but in general may also be used to perform any desired processing.

The Applicant believes, however, that there remains scope for improved arrangements in the operation of graphics processors that are operable to support different processing flows.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows an example of a geometry packet pipeline that may be executed by the graphics processor;

FIG. 5 shows schematically an arrangement of processing circuitry according to an embodiment;

FIG. 6 shows in more detail an arrangement of processing circuitry for implementing a packet shading pipeline according to an embodiment;

FIG. 7 shows schematically an arrangement of state/configuration storage according to an example;

FIG. 8 shows an example of a “work graph”;

FIG. 9 shows examples of various paths through the work graph that can be executed by respective processing pipelines;

FIG. 10 shows further details of the arrangement of processing circuitry for implementing the packet shading pipeline according to an embodiment;

FIG. 11 shows an example of a node descriptor array according to an embodiment;

FIG. 12 is a flow chart showing the operation of the pipeline manager according to an embodiment;

FIG. 13 shows schematically packet iterator state that may be used according to an embodiment;

FIG. 14 is a flow chart showing the operation of the packet iterator according to an embodiment;

FIG. 15 shows an example packet data structure according to an embodiment; and

FIG. 16 shows schematically the overall processing flow to execute a work graph according to an embodiment.

### DETAILED DESCRIPTION

A first embodiment of the technology described herein comprises a graphics processor comprising:
one or more processing circuits to execute a sequence of pipeline stages for a processing pipeline, the one or more processing circuits including:
a set of work queues identifying packets to be processed by the respective pipeline stages, wherein a packet contains one or more work items on which processing is to be performed;
an iterator circuit to process packets; and
a pipeline manager operable to select packets from the set of work queues for processing by the iterator circuit,
wherein for a particular instance of executing the processing pipeline, the iterator circuit when performing processing for a given pipeline stage of the processing pipeline is operable to invoke various processing operations to process respective sets of one or more work items that are to be processed by that pipeline stage,
with the particular processing operation that is invoked by the iterator circuit to process a particular set of one or more work items being determined and specified for that particular set of work items itself.

A second embodiment of the technology described herein comprises a method of operating a graphics processor,
the graphics processor comprising:
one or more processing circuits to execute a sequence of pipeline stages for a processing pipeline, the one or more processing circuits including:
a set of work queues identifying packets to be processed by the respective pipeline stages, wherein a packet contains one or more work items on which processing is to be performed;
an iterator circuit to process packets; and
a pipeline manager operable to select packets from the set of work queues for processing by the iterator circuit,
wherein for a particular instance of executing the processing pipeline, the iterator circuit when performing processing for a given pipeline stage of the processing pipeline is operable to invoke various processing operations to process respective sets of one or more work items that are to be processed by that pipeline stage, and
the method comprising:
for a set of one or more work items within a packet that is to be processed for a respective pipeline stage of the processing pipeline, and for which a particular processing operation is specified to process that set of one or more work items:
the iterator circuit:
identifying the particular processing operation that is specified to be performed to process that set of one or more work items; and then
invoking the specified processing operation to process the set of one or more work items.

The technology described herein relates to graphics processors that are operable to execute processing pipelines that may comprise a certain logical sequence of pipeline stages to produce a desired output.

A (and each) pipeline stage of the processing pipeline of the technology described herein may, and generally will, be operable to invoke various processing operations to process respective work items that are to be processed by the pipeline stage. For example, and typically, a given pipeline stage may invoke one or more shader program (e.g. a compute shader) to process a respective set of one or more work items to be processed by that pipeline stage, as will be explained further below, but in general the pipeline stages may invoke any suitable and desired processing operations depending on the particular instance of processing pipeline to be executed.

To support this operation, the graphics processor thus comprises a set of one or more processing circuits to execute the sequence of pipeline stages for the processing pipeline (and these processing circuits are operable to invoke the required processing operations to execute the desired pipeline stages, e.g. by triggering appropriate (e.g. compute) shader program execution, as will be explained further below).

In this respect, there will in embodiments be defined, for a particular instance of executing the processing pipeline, a respective set of ‘available’ processing operations that can be invoked by the pipeline stages for that particular instance of executing the processing pipeline. Thus, for a particular instance of executing the processing pipeline, (the processing circuit(s) executing) a given pipeline stage of the processing pipeline may be operable to invoke processing operations from such set of ‘available’ processing operations to process respective sets of one or more work items to be processed by that pipeline stage.

For example, and in embodiments, the graphics processor has access to a memory, which memory may, e.g., and in embodiments is, external to the graphics processor, and in which there is stored a set of configuration information associated with and defining a corresponding set of ‘available’ processing operations that has been determined for the current instance of executing the processing pipeline. This set of ‘available’ processing operations may be determined, for instance, by an initial compilation or configuration process, as will be explained further below, and the associated configuration information stored appropriately in (external) memory in advance of executing the processing pipeline.

When executing the processing pipeline, these processing operations can then be invoked by respective pipeline stages to process the respective sets of work items to be processed by those pipeline stages, and as part of this, the graphics processor may load the relevant configuration information from its location in memory into the graphics processor, as needed, so that the operation of the processing circuit(s) executing the pipeline stage in question can be controlled appropriately to invoke the desired processing operation(s).

Further, in the technology described herein, for a particular instance of executing a processing pipeline (e.g. comprising a particular configuration of one or more pipeline stages), rather than there then being a certain specified mapping between the pipeline stages and the processing operations that will be invoked by those pipeline stages that may then be fixed, e.g. until/unless the processing pipeline is re-configured, the processing operation that is invoked by a given pipeline stage to process a particular set of one or more work items that is to be processed by that pipeline stage can be, and is, dynamically determined and specified for that particular set of one or more work items itself.

Accordingly, there will in embodiments be a respective set of ‘available’ processing operations defined for the current instance of executing the processing pipeline. The particular processing operation (from this set) that should be invoked by a given pipeline stage when processing a respective set of one or more work items that is to be processed by that pipeline stage will then be appropriately determined (e.g., and in embodiments, in use) and specified for that particular set of one or more work items itself.

Thus, (the processing circuit(s) executing) the pipeline stage is generally operable to identify, for a set of one or more work items that is to be processed for that pipeline stage, the particular processing operation that is specified to be performed for that set of one or more work items. The pipeline stage may, and in embodiments will, then obtain the relevant configuration information associated with that particular processing operation, e.g. from its location in memory, and use the configuration information to invoke the specified processing operation to process the set of one or more work items.

An effect and benefit of this therefore is that for a particular instance of executing a processing pipeline, a particular ‘same’ pipeline stage of the processing pipeline may be flexibly operable to invoke multiple different processing operations for different sets of work items that are to be processed by that particular same pipeline stage.

That is, rather than the processing operations performed by the respective pipeline stages being fixedly determined based on the configuration of the processing pipeline, i.e. such that a first pipeline stage will always perform a same first processing operation for all sets of work items that are to be processed by the first pipeline stage, and so on for the other pipeline stages, in the processing pipeline of the technology described herein a particular, same pipeline stage can flexibly perform different processing operations for different sets of work items that are to be processed by that particular same pipeline stage, with the particular processing operation that is performed for a respective set of work items being determined and specified for that particular set of work itself.

For example, and in embodiments, the particular processing operation that is performed for a respective set of work items may be specified by appropriate metadata associated with the particular set of work.

In other words, rather than the pipeline stages defining a single, static processing pipeline configuration, the pipeline stages that are executed by the graphics processor in the technology described herein may, e.g., and in embodiments do, simply manage the general flow of data, e.g., and in embodiments, by passing respective “packets” of data (with a “packet” generally containing a collection of (sets of) work items on which further processing is to be performed) produced by one pipeline stage to a next pipeline stage for processing, and so on, but the data (i.e. work items) that passes between the pipeline stages, and the processing operations that are performed thereby, can be dynamically defined by the graphics processor in use (and the graphics processor of the technology described herein is operable and configured to be able to support this operation) (e.g., and in embodiments, with the relevant configuration information to perform those different processing operations being obtained (from memory) and transferred to the processing circuit(s) executing the pipeline stage in question as and when it is needed to process a particular set of work items).

This is in contrast to more traditional graphics processor operation, in which when the graphics processor is to support a particular processing pipeline, there would normally then be an essentially static mapping between pipeline stages and the processing operations that are performed by those pipeline stages.

In this way, the graphics processor may be operable to support more dynamic processing flows, in particular including those based on so-called “work graph” programming models, as will be explained further below.

Correspondingly, and as will be explained further below, the technology described herein provides efficient mechanisms for managing and supporting such dynamic processing flows within the graphics processor (hardware), e.g., and in embodiments, without increasing the burden on the application programmer.

For instance, as mentioned above, a work graph as described in the Direct3D 12 API, is a directed graph that contains a collection of nodes, with each node able to invoke a respective processing operation, and with the edges between nodes defining respective paths along which “records” of data can be passed.

A given node within the work graph may thus receive one or more input “records” of data that are to be processed by that node and the processing of an input record may produce a corresponding zero or more output “records” of data for further processing by a next node within the work graph. The processing to produce the output records will in embodiments also determine to which next node within the work graph the output records should be passed for further processing.

Thus, an output record produced by a given node may then be passed, as input, to another node within the work graph for further processing. The work graph will accordingly define the relationships between the nodes, i.e. defining for a given node within the work graph an associated set of (child) nodes that the given node can potentially pass data to for further processing. However, rather than data always being passed along a same sequence of nodes, this is determined dynamically by the work graph processing such that when a node produces an output record, the processing within that node will also determine to which of the nodes in its associated set of (child) nodes the output record should be passed to for further processing.

In this way, the data flow through the work graph can be dynamically determined by the graphics processor itself, in use, based on the processing that is performed. Indeed, an effect and benefit of the work graph programming model is to allow the graphics processor to effectively drive its own workload, thus providing the application programmer with greater flexibility.

In this respect, a particular data “path” through the work graph defined by a sequence of (connected) nodes will thus involve a certain sequence of processing operations, with those processing operations being defined by the respective sequence of nodes along that path. The sequence of nodes along a given path will thus effectively define a processing pipeline, having a sequence of pipeline stages that map to the different nodes along the path. Thus, a given work graph could conceptually be decomposed into a plurality of processing pipelines, each processing pipeline representing a different possible path through the work graph. In principle, therefore, each unique path through the work graph could be mapped to a different processing pipeline, and the graphics processor could be operable and configured to separately support each of these different processing pipelines (either in software, and/or hardware, as desired).

It will be appreciated however that the size of a work graph is effectively unbounded. For example, although the Direct3D 12 API currently restricts the “depth” of a work graph to 32 nodes (including any self-recursion), a work graph may have an essentially unlimited lateral extent. A single work graph could therefore contain thousands of individual nodes (or more), and so there will correspondingly be a larger number of possible paths through the work graph.

Further, as mentioned above, which path is selected will typically be determined in use based on the processing of the respective records within the work graph. Thus, consecutive records could be routed along different paths, and if each path were to be treated as a separate processing pipeline, the graphics processor may therefore have to repeatedly switch in use between different processing pipelines, which may significantly limit throughput.

Thus, the Applicant recognises that it may not be generally practical to map each and every possible path through the work graph to a separate processing pipeline, and to then try to support each of those processing pipelines.

Accordingly, rather than attempting to map pipeline stages to individual nodes of the work graph (which the Applicant recognises will not generally be practical), in the technology described herein, for an instance of processing pipeline to execute a work graph, the pipeline stages are effectively mapped to respective ‘depth levels’ of the work graph.

A given pipeline stage is then operable to execute multiple nodes at its respective depth level of the work graph, and is in embodiments operable to execute processing for any and all nodes at its respective depth level of the work graph, with the particular node that is to be executed, and hence processing operation to be invoked, to process a particular record being specified for that record.

Thus, in embodiments, for a particular instance of executing the processing pipeline to execute a work graph containing a set of connected nodes, in which respective nodes of the work graph can invoke respective processing operations, and in which the work graph contains one or more paths of nodes along which data can be passed, and wherein a respective path contains a sequence of one or more nodes defining a corresponding one or more depth levels of the work graph, the pipeline stages of the processing pipeline are mapped to the respective depth levels of the work graph so that a given pipeline stage is operable to execute processing for multiple different (e.g. any and all) nodes at its respective depth level of the work graph.

For instance, as mentioned above, a work graph is a directed graph, and other than self-recursion (which is permitted), the work graph should be acyclic so that data will always flow along the work graph from an ‘entry’ node at a top level of the work graph to a respective ‘exit’ node that terminates the work graph. An ‘exit’ mode of a work graph may trigger any suitable and desired further processing, as desired. For example, in embodiments, an exit mode may be a ‘mesh’ node that is operable to invoke execution of a mesh shader, and the output of the mesh node (shader) can then be fed appropriately into the graphics processing pipeline (e.g. for rasterisation), but various other arrangements would be possible in this regard. Between the entry and exit nodes, the data may further pass through one or more internal nodes at different respective ‘depth levels’ of the work graph.

Thus, a work graph will have one or more ‘entry’ nodes at a top level of the work graph (e.g. at a depth level ‘0’) and in embodiments a first pipeline stage will correspondingly be used to execute processing for any all such entry nodes.

An (and each) entry node may then be connected to a respective set of one or more ‘child’ nodes, wherein an entry node can pass records to any of its child nodes for further processing. The total set of child nodes that can potentially receive records from an entry node will accordingly define a next level of the work graph (e.g. at depth level ‘1’). A second pipeline stage will in embodiments thus be used to execute processing for any and all nodes at this depth level, i.e. any nodes to which an entry node can pass records to. The child nodes at this level may in turn, and typically will be, connected to further child nodes, and so on, down to a set of one or more exit nodes that terminate execution of the work graph.

When the processing pipeline is executing a work graph, respective pipeline stages of the processing pipeline can thus be mapped to different respective depth levels within the work graph, with a given pipeline stage in embodiments being used to execute processing for any and all nodes at its respective depth level.

In this regard, it will be appreciated that a given node may be a child node for multiple different parent nodes, potentially at different depth levels. Similarly, it will be appreciated that the work graph may have a single, common exit node that terminates all paths, or may have multiple exit nodes. It will also be noted that a particular node may also be able to pass work back to itself, e.g. in a self-recursive manner. A given node of the work graph may thus appear in different paths at different depth levels, and so may need to be executed by different pipeline stages.

Thus, a particular, same pipeline stage may need to execute multiple different nodes of the work graph.

Correspondingly, different pipeline stages may need to execute different instances of the same nodes of the work graph.

An effect and benefit of the technology described herein however is that the processing pipeline may flexibly support any suitable arrangement of nodes within a work graph, and this is in embodiments done automatically within the graphics processor (hardware) without placing any particular limitations on the application programmer, e.g. beyond those that may already imposed by the API.

When executing an instance of the processing pipeline that corresponds to a work graph, therefore, the pipeline stages will map to depth levels within the work graph. In that case, a given pipeline stage, associated with a certain depth level, may thus be able to invoke respective processing operations for any and all of the nodes at that depth level.

Thus, in the case that the processing pipeline is to execute a work graph, the entities that are processed by the pipeline stages of the processing pipeline may, e.g., and in embodiments do, comprise respective “packets” that contain one or more data “records” (or sets of records), with the packet storing, for each record within the packet, the data (to be processed) for that record, and in embodiments also storing metadata indicating the particular node of the work graph that the record is to be processed for. The metadata associated with the record will thus in embodiments comprise a respective node identifier identifying the particular node within the work graph that is to be executed to process that record. In this way, as discussed above, the particular processing operation that will be performed for a given record (or set of records) (within a packet) can be specified for that record itself.

Thus, in embodiments, the packets to be processed by the processing pipeline may contain sets of one or more records to be processed, and there is stored within a given packet associated record metadata indicating for the respective records within the packet the respective nodes that are to be executed to process those records.

In the context of a work graph, therefore, there will in embodiments be defined for the work graph, a respective set of configuration information associated with and defining a corresponding set of processing operations that can be invoked by the pipeline stages, with the respective processing operation in turn corresponding to respective individual nodes within the work graph.

The pipeline stages when processing a packet containing one or more records can then identify, for each record, the respective node that is to be executed to process that record, and then obtain the relevant configuration information for that node so that the appropriate processing operations can be invoked to process the record.

Accordingly, there will in embodiments be stored, in (external) memory, an array of node descriptors that stores, for respective nodes within the work graph, the relevant configuration information that will be needed by the processing circuit(s) executing the pipeline stages to invoke the particular processing operations that should be performed to execute that node. The node identifiers that are stored in association with the records to be processed can thus be used to look up the associated entries within the array of node descriptors to obtain the relevant configuration information for the nodes in question.

In this respect, it will be appreciated that a given node of the work graph may generally invoke any suitable and desired processing operation. Typically, and in embodiments, this will be a respective shader program (e.g. a compute shader) that the node should invoke.

Thus, in embodiments, the processing operations that can be invoked by the pipeline stages correspond to shader programs, and the configuration information that is stored in the respective entries of the array of node descriptors for respective nodes will include at least an identifier of the shader program that is to be invoked by that node. The shader program may be specified relative to a pre-computed shader binding table, for instance.

The configuration information that is stored in the respective entries of the array of node descriptors for respective nodes will include at least an identifier of the shader program that is to be invoked by that node may also contain any other desired information needed to execute the node. This may include semantics based on the node ‘type’. For instance, a work graph may contain multiple different node ‘types’ that may be operable to launch shader programs (or other processing operations) in different ways, e.g., and for different numbers of records at a time, and this information will in embodiments also be specified as part of the configuration information for that node.

The array of node descriptors will typically be populated when compiling the work graph. Thus, for a particular instance of processing pipeline to execute a work graph, an initial compilation process will in embodiments produce a respective array of node descriptors for storing the configuration information for the nodes within the work graph, and this array of node descriptors will then be stored appropriately in (external) memory accessible to the graphics processor.

Once the initial compilation process has been performed, the processing pipeline can then be run to execute the work graph. To do this, input data will typically be provided, e.g. from a software-controlled buffer, to the ‘entry’ node or nodes at the top of the work graph. As discussed above, the first pipeline stage will then execute the entry nodes to process this input data, and this processing will produce zero or more output records that are to be passed to a next node within the work graph for further processing. The first pipeline stage when executing the entry node will thus produce and output a “packet” containing one or more records that are to be further processed within the work graph, and it will be specified for each record within the packet which node is to be executed to process that record.

The packets produced by the first pipeline stage will then be passed to second pipeline stage, and the second pipeline stage will read the packets and process the records within the packets in turn, identifying the nodes that are to be executed and obtaining the relevant configuration information, as needed. This will be repeated for each pipeline stage, and each packet, etc., to execute the work graph. The pipeline stages thus manage the flow of data through the work graph, by passing respective “packets” of records from one pipeline stage to the next, but the particular processing that is performed for those records is dynamically determined and specified for those records.

In this way, the graphics processor can support more dynamic processing flows, as discussed above.

Whilst a particular example is given above in relation to executing an instance of processing pipeline to support a work graph programming model it will be appreciated that the approach described above may generally be used to support any suitable and desired processing flow.

That is, the approach according to the technology described herein is highly flexible and may generally support any suitable and desired processing flow. Thus, in embodiments, the processing operations that are available to be invoked can be any suitable processing operations that may be appropriately specified to be invoked by a given pipeline stage to process a respective set of one or more work items (and so the configuration information that defines these processing operations does not have to correspond to configuration information for nodes within a work graph, but could correspond to configuration information for any other suitable instances of processing).

Various arrangements would be possible in this regard.

The approach according to the technology described herein allows the graphics processor to more efficiently support execution of more dynamic processing flows, including those based on work graph programming models.

Thus, in embodiments, the graphics processor (and processing pipeline) is operable and configured to support work graph programming models.

It will be appreciated however that the graphics processor (and processing pipeline) of the technology described herein may generally support any desired processing flows. Indeed, it is an effect and benefit of operating in the particular manner of the technology described herein that since the mapping between pipeline stages and the processing operations that are to be invoked by those pipeline stages can be dynamically determined in use the processing pipeline can be flexibly used to support any suitable and desired processing flow.

For instance, as discussed above, a particular benefit of the approach according to the technology described herein is that the graphics processor can support more dynamic processing pipelines, in particular in which the processing operations to be performed by a given pipeline stage to process particular sets of work items can be, and are, specified for the particular sets of work items, such that a particular, same pipeline stage can invoke multiple different processing operations, with this being determined dynamically, i.e. in use.

Thus, at least when operating in the particular manner of the technology described herein, the processing operation that is invoked by the pipeline stage for a particular set of one or more work items will be determined and specified for that particular set of one or more work items itself, and the graphics processor (hardware) is able to then respond to this appropriately, e.g., and in particular, by invoking the specified processing operation, as described above.

In embodiments, however, the graphics processor of the technology described herein is also (still) operable to support more ‘static’ processing pipelines, e.g. in which at least for a particular configuration of processing pipeline there is an essentially fixed mapping between pipeline stages and the processing operations that those pipeline stages are to perform.

In embodiments this is done using the same set of one or more processing circuits that will execute more dynamic processing pipelines.

In this case, a static processing pipeline could be managed using the same mechanisms that are used to support more dynamic processing pipelines, where the processing operations to be invoked by respective pipeline stages are specified for the respective sets of work items input to those pipeline stages, except in this case a particular, same pipeline stage should always perform the same processing operation (and so the same processing operation should be specified for all sets of work items input to the same pipeline stage).

Alternatively, and in embodiments, the graphics processor may be selectively operable in a different manner, where when the graphics processor is to execute a more static processing pipeline, the graphics processor can identify this situation, and the configuration information needed to execute the pipeline stages in that case is in embodiments then stored on the graphics processor and obtained on a per-pipeline stage basis, i.e. rather than being specified and obtained for particular sets of work items as and when those sets of work items are processed.

Thus, the particular operation in the manner of the technology described herein may in embodiments be selectively enabled/disabled depending on the type of processing flow that is being supported.

Various arrangements would be possible in this regard.

The technology described herein may therefore provide various benefits compared to other possible approaches.

Subject to the particular requirements of the technology described herein, the graphics processor may contain any suitable and desired processing circuits to execute the pipeline stages of the processing pipeline.

In embodiments, the processing pipeline that is executed is operable to process “packets” of work items.

In this respect, a “packet” may generally comprise any suitable and desired collection of work items to be processed, and which work items may, e.g., depending on the pipeline stage in question and the processing to be performed for that packet, comprise any suitable and desired set of work items. A “packet” may thus contain one or more sets of (similar) work items that should be processed by a single task.

For example, in the context of geometry processing, the work items within a packet may comprise any of vertices, meshes, tasks, bounding boxes, primitives, etc., for which processing is to be performed.

In general, however, the packets that are processed by the processing pipeline may contain any suitable and desired data that may be produced by one pipeline stage and then consumed by a later pipeline stage, and various arrangements would be possible in this regard.

Thus, in the case of a work graph programming model, as discussed above, a respective packet may, and in embodiments will, contain a set of one or more data “records”. The sets of work items to be processed in the case of a work graph will thus comprise sets of one or more records. In embodiments, as alluded to above, a packet will also identify, for the respective records within the packet, which nodes of the work graph are to be executed for those records. For instance, this could be done by storing a respective node identifier for each record, or by indicating a number of records to be processed for each node, and various arrangements would be possible in this regard.

Thus, each pipeline stage may be, and in embodiments is, operable and configured to generate data elements for a set of work items (such as a set of “records” in the case of a work graph), and the pipeline stages are operable to manage the processing of such sets of work items at a “packet” granularity.

Accordingly, the entities that pass through the logical sequence of pipeline stages of the graphics processing pipeline, and for which processing is performed within the pipeline stages of the graphics processing pipeline, in embodiments comprise respective “packets” comprising (data for) typically plural of the work items (e.g. records, etc.) that the respective pipeline stages are generating data for.

(As will be discussed further below, the processing pipeline that is executed in the technology described herein may also be operable to process other items of work, such as commands to update state and/or to trigger processing work.)

The processing pipeline will thus comprise a certain sequence of pipeline stages, with any packets (and/or commands, etc.) produced/output from one pipeline stage in embodiments then being passed as input to a next pipeline stage, and so on, to execute the logical sequence of pipeline stages that are to be executed as part of the overall processing pipeline.

In the technology described herein, however, rather than each pipeline stage being supported by its own dedicated processing circuit, with these circuits being connected in a pipelined manner to map to the processing pipeline that is being executed, the logical sequence of pipeline stages is executed using a set of processing circuits that is in effect shared between multiple (e.g. all) of the different pipeline stages within the logical sequence of pipeline stages to be executed as part of the processing pipeline.

Thus, any, and in embodiments each, of the pipeline stages within the logical sequence of pipeline stages to be executed as part of the processing pipeline can be executed using the same underlying processing circuits (e.g. hardware).

This then means that the processing pipeline may generally contain different logical sequences of pipeline stages, including different numbers of pipeline stages, and this can be adaptively supported by the same underlying (shared) processing circuits. Thus, in embodiments, the number of pipeline stages executed as part of the processing pipeline can be configured and re-configured in use. For example, and in embodiments, in the case of configuring the processing pipeline to execute a work graph programming model, the number of pipeline stages that are configured as part of the processing pipeline may be set/configured based on the maximum depth path through the work graph.

For instance, as mentioned above, for an instance of processing pipeline to execute a work graph, respective pipeline stages are in embodiments mapped to respective depth levels of the work graph. The number of pipeline stages that will need to be supported may accordingly be configured/set based on the maximum depth of the work graph. In this regard, according to the current Direct3D 12 API specification, the depth of a work graph should be restricted to 32 nodes (and this includes any self-recursion). Thus, the maximum depth of a work graph is generally 32 nodes, and so the maximum number of pipeline stages that may need to be supported to execute a work graph will correspondingly be 32 (although it will be appreciated that a given work graph may have a smaller maximum depth, in which case a correspondingly lower number of pipeline stages may be configured to support execution of that work graph).

Various other arrangements would of course be possible.

For instance, although Direct3D 12 API specification currently limits the depth of a work graph to 32 nodes, in principle a work graph may have any depth, and the technology described herein may generally be used to support any suitable work graphs, as desired.

As will be explained further below, there may be a number of shared resources that are then assigned/configured based on the number of pipeline stages to be supported. For example, as will be explained further below there may be a shared work buffer and/or memory buffer that can be partitioned based on the number of pipeline stages to be supported, e.g. as part of an initial configuration of the graphics processor, and then re-configured as needed for another instance of processing pipeline execution. Alternatively, in some embodiments, the work buffer and/or memory buffer may always be configured to handle the maximum number of pipeline stages (e.g. at least 32 in order to support work graph execution), without this being configurable.

In embodiments, therefore, rather than providing a static arrangement of standalone processing circuits, wherein each respective processing circuit is operable and configured to execute a respective, single pipeline stage, a processing pipeline may include a certain sequence of pipeline stages in which each pipeline stage within the sequence of pipeline stages may be, and in embodiments is, executed using the same underlying (shared) processing circuits.

The use of the (shared) processing circuits to execute the processing pipeline means that the graphics processor is able to more flexibly accommodate different numbers of pipeline stages within the processing pipeline.

This may therefore provide more efficient use of silicon (area), and/or allow more complex processing pipelines (e.g. having larger numbers of pipeline stages) to be supported, e.g., and in embodiments, without having to provide additional dedicated circuits to do so.

This can also improve overall graphics processor performance. In particular, depending on the number of pipeline stages that are to be executed as part of a particular instance of processing pipeline execution, appropriate and different amounts of the processing resource provided by the set of shared processing circuits that is used to execute the sequence of pipeline stages can be made available for those pipeline stages.

Thus, if there are relatively fewer pipeline stages to be executed as part of the processing pipeline, these pipeline stages may then be provided with relatively increased use of such shared processing resource. This can therefore provide potentially improved performance, at least in certain situations, e.g. compared to more static arrangements where the amount of processing resource available to each pipeline stage may be essentially fixed. Further, in such static arrangements, if there are fewer pipeline stages required for a particular processing pipeline than there are available processing circuits, some of the processing circuits may simply be disabled/not used, which may not be an efficient use of silicon (area).

Conversely, if there are a relatively greater number of pipeline stages to be executed as part of the processing pipeline, this can be accommodated by simply allocating appropriate use of the processing resource provided by the set of shared processing circuits that is used to execute the sequence of pipeline stages to the different pipeline stages.

As mentioned above, the logical sequence of pipeline stages is executed using a set of processing circuits that is shared between the different pipeline stages within the logical sequence of pipeline stages to be executed as part of the processing pipeline. The processing resource provided by the set of processing circuits can therefore be, and in embodiments is, shared between multiple, different pipeline stages in use.

For instance, in this regard, some of the processing resource provided by the set of shared processing circuits that is used to execute the sequence of pipeline stages will be effectively shared on a time-division basis, i.e. so that certain processing logic is operable to perform processing for any particular pipeline stage within the logical sequence of pipeline stages to be executed as part of the processing pipeline, but may only be able to perform that processing for one particular pipeline stage at a time.

Similarly, there may be other shared resource (such as a shared work ‘buffer’, as will be discussed further below) that will be effectively partitioned between the different pipeline stages, based on the number of pipeline stages that are to be executed as part of the processing pipeline.

Subject to the particular requirements of the technology described herein, the set of shared processing circuits that executes the logical sequence of pipeline stages may comprise any suitable and desired set of shared processing circuits.

In particular, the graphics processor comprises one or more processing circuits to execute the sequence of pipeline stages that will include an iterator circuit to process certain sets of work (items) (for (and to execute) the pipeline stages of the processing pipeline).

This iterator circuit (which may also be referred to herein as a “packet iterator”) will then performs the required processing to execute the different pipeline stages that are to be executed.

There will also be a set of work queues for storing the respective sets of work (i.e. “packets”) to be processed for the different pipeline stages within the sequence of pipeline stages (and which work queues can optionally also store other items, e.g. commands, to be processed by the processing pipeline) and a pipeline manager that is operable to provide packets from the respective work queues to the iterator circuit for processing, and to manage the overall execution of the sequence of pipeline stages.

In some embodiments, there is a single iterator circuit that is shared between, and executes, all of the different pipeline stages within the processing pipeline, and a single pipeline manager.

It would also be possible for there to be more than one iterator circuit, with either a single pipeline manager operable to provide sets of work (e.g. packets) to the different iterator circuits, as appropriate, or with separate pipeline managers being provided for each iterator circuit. This may then allow some degree of parallelisation or overlap between pipeline stages.

In general, however, the number of pipeline stages that can potentially be executed will be greater than the number of iterator circuits, such that the iterator circuit will typically have to (and is therefore operable and configured to) support the execution of multiple, different pipeline stages.

In this respect, it will be appreciated that a given pipeline stage within the processing pipeline may generally produce for an incoming packet of work (which incoming packet of work may, e.g. correspond to an incoming “packet” of work items (e.g. records) that has produced by a previous pipeline stage, but in the case of an “entry” node to a work graph, for instance, could also correspond to a set of input work that is provided from a suitable software buffer, and various arrangements would be possible in this regard), a corresponding set of zero or more (child) output packets.

The output packets from a given pipeline stage will in turn be passed to a next processing stage, e.g. a next pipeline stage, or output unit, within the processing pipeline for further processing.

A given pipeline stage may therefore generally receive as input a stream of incoming packets (or other work, etc., as the case may be), and in turn may correspondingly produce a stream of output packets, e.g. that are to be passed as input to a next processing stage of the processing pipeline. The processing within a current pipeline stage may thus generate the (data for) the packets that will be produced and output by that pipeline stage. A next processing stage may accordingly receive the output packets and determine which (if any) further processing is to be performed for those packets.

To track this, in the technology described herein, a set of work queues is provided that is used to identify the packets of work that are to be processed for the different pipeline stages. For instance, each pipeline stage may, and in embodiments does, have its own respective work queue which is operable to store a list of identifiers for the respective packets of work that are to be processed for that pipeline stage.

The pipeline manager that manages the overall execution of the sequence of pipeline stages is thus operable to select a next item to be processed from any of the work queues within the set of work queues, and at least when the next item is a packet containing one or more work items (e.g. records) to be processed, to then provide the selected packet to the iterator circuit for processing.

This selection of the next item to be processed can be done in any suitable and desired manner, e.g. using any suitable arbitration scheme between the work queues, but so long as there are available and valid items, i.e. that are ready to be processed, within the work queues, the pipeline manager may generally select a next item (e.g. packet, etc.) for processing from any of the work queues within the set of work queues.

As described above, the iterator circuit is in embodiments operable to perform processing for sets of work items for multiple, different (e.g. each and any) of the pipeline stages within the sequence of pipeline stages that is being supported by the set of shared processing circuits.

That is, in order to execute the sequence of pipeline stages, the (same) iterator circuit will process sets of work for a first pipeline stage but will in embodiments also process sets of work for second or further pipeline stages within the sequence of pipeline stages, with the iterator circuit effectively being shared, on a time-division basis, between the different pipeline stages.

Further, in the technology described herein, the particular processing operation that is invoked by the iterator circuit to process a particular set of one or more work items (e.g. within a packet) may, e.g., and typically will, be specified for that particular set of one or more work items itself.

Accordingly, when a set of work (e.g. a packet) is selected for processing, the processing that will be performed for the work items within that set of work (packet) will depend on the work items in question.

The iterator circuit will thus need to be appropriately controlled to perform the relevant processing operations, depending on the processing operations specified to be performed for the set of one or more work items (e.g. records) in question. The iterator circuit thus comprises appropriate logic to control its processing of sets of work items according to the particular processing operations that are specified to be performed for those sets of work items.

However, the processing steps (and logic) performed by the iterator circuit are in embodiments ‘generic’, so that the same basic processing steps are performed by the iterator circuit for any and all packets (and any and all sets of work items within those packets) that may be processed by the iterator circuit, independently of which pipeline stage is being executed, but these same basic processing steps will trigger different processing of depending on the particular set of work that is to be processed by the iterator circuit.

To facilitate this, as alluded to above, in embodiments the graphics processor has access to a memory in which there is stored a respective set of configuration information defining a corresponding set of ‘available’ processing operations that have been defined for the current instance of processing pipeline execution. This configuration information will then be used to control operation of the processing circuits to execute the desired processing operations.

Thus, for a given instance of processing pipeline to execute a desired processing flow, a suitable set of configuration information defining a corresponding set of (all of the) different possible processing operations that can be invoked by the pipeline stages of that processing pipeline may be generated, which configuration information can then be suitably be stored in a memory accessible by the graphics processor.

For example, for an instance of processing pipeline to execute a work graph programming model, a respective item of configuration information may be produced for each individual node within the work graph, which configuration information contains the relevant state needed to execute that node.

In this respect, and in embodiments, as mentioned earlier, a (and in embodiments each) node within a work graph may be operable to invoke a respective compute shader program, although in principle a given node could trigger other suitable processing, as desired.

The configuration information that is stored for a given node may thus indicate inter alia a particular shader program that is to be invoked, as well as any associated job size information, (thread) dispatch parameters, e.g. specifying a number of input records that the shader program can be simultaneously executed for, etc., to be used when invoking that shader program.

Again, given the potentially larger number of nodes within a single work graph, the present Applicant recognises that it may not be practical to (try to) store all of this configuration information locally to the graphics processor, and so as alluded to above, this configuration information is in embodiments stored in (external) memory, e.g., and in embodiments, as an array of node descriptors.

The array of node descriptors will thus store, for respective nodes within the work graph, the respective configuration information that will be needed (by the iterator circuit) to execute that node. This array of node descriptors can be produced during an initial compilation process. For example, an application may build a work graph, and when this is to be submitted to the graphics processor, a (software) driver for the graphics processor, when compiling the work graph, can build this array of node descriptors and populate it accordingly with the relevant configuration information for the work graph.

Various arrangements would be possible in this regard.

At runtime, when running the processing pipeline execute the work graph, each pipeline stage may receive sets of work (e.g. packets) containing records to be processed, and each record in embodiments identifies the node that is to be executed to process that record. The graphics processor can thus use the node identifier to look up and obtain the relevant configuration information from its location in the memory and load this into the iterator circuit so that the iterator circuit can invoke the appropriate processing operations to process the record in question.

In this respect, it will be appreciated that the graphics processor may, at this point, only load in the particular configuration information that is needed by the iterator circuit, and that there may be other configuration information that is stored in the memory that is not necessarily loaded in at this point (but may be loaded in later, e.g. if that is needed by other processing stages/circuits). Thus, in general, the relevant configuration information that is loaded in at this point will include the configuration information that is relevant to the operation of the iterator circuit, and this may correspond to only part of the overall configuration information that is stored for a particular node.

Thus, in embodiments, the graphics processor is operable and configured to identify, for a particular set of one or more work items (e.g. a record, or set of records that can be processed together), the particular processing operation that is to be performed to process that particular set of one or more work items, and to then obtain the relevant configuration information that is needed to invoke that processing operation. Further, this is in embodiments done dynamically, in use, with the relevant configuration information being obtained as and when it is needed.

To facilitate the transfer of configuration information between the (external) memory in which it is stored and the processing circuit(s) (e.g. the iterator circuit) that will use the configuration information to execute the pipeline stages, the graphics processor in embodiments further comprises storage that is operable to hold configuration information locally to the graphics processor. This storage in embodiments comprises a cache via which the configuration information can be obtained.

Thus, when an item of configuration information is required for a particular processing operation (e.g. to execute a particular node), a lookup can then be performed based on an appropriate identifier for that processing operation, which lookup will be performed by first checking whether the relevant configuration information is already present in the cache provided by the graphics processor's local storage. If the relevant configuration information is already present in the cache provided by the graphics processor's local storage, the configuration information will then be returned from such storage. Otherwise, the relevant configuration information will be fetched from its location in memory into the cache provided by the graphics processor's local storage, and then provided from such storage to the iterator circuit, e.g. in the normal manner for such cache operations.

Various arrangements would be possible in this regard.

The storage may also store any other suitable desired pipeline configuration information. For example, the storage in embodiments also stores some overall pipeline configuration information that relates to the processing pipeline as a whole (and that may therefore be common to all pipeline stages/packets that are to be processed). This common pipeline configuration information may for example define the number of pipeline stages that are to be executed, as well as viewport parameters, etc., that may be statically defined for the processing pipeline.

When the processing pipeline is operated in the particular manner of the technology described herein, in which configuration information can be loaded into the graphics processor as and when required to process particular sets of work items, the storage will thus operate in a ‘cache’ like manner to dynamically load in the relevant configuration information. As mentioned above, however, the graphics processor of the technology described herein may still be used to support execution of more static processing pipelines. In that case, the configuration information may be stored and produced on a per-pipeline stage basis, so that once the processing pipeline has been configured, the configuration information defining the processing operations to be performed by the respective pipeline stages will remain static until/unless the processing pipeline is reconfigured. Thus, in some embodiments, the (same) storage may also store configuration information relating to the individual pipeline stages within the processing pipeline.

Various arrangements would be possible in this regard.

Thus, when operating in the particular manner of the technology described herein, when the packet iterator is to process a set of one or more work items (e.g. a record) for a particular pipeline stage, the processing that is performed by the iterator circuit is determined and controlled based on the configuration information that applies to the particular set of work items in question. The relevant configuration information should can thus be, and in embodiments is, provided to the iterator circuit to control this, and the configuration information is in embodiments provided via such storage.

In this way, the iterator circuit can be, and is, caused to control the processing of a set of work items for a particular pipeline stage according to the respective processing operations that are specified to be performed for that particular set of one or more work items.

For example, a given pipeline stage may receive an incoming packet of work to be processed, and will then perform appropriate processing for the work items within that packet, depending on the particular processing operations specified to be performed.

In general, this processing will involve determining a corresponding one or more (child) output packets to be produced by, and processed within, the pipeline stage. In this respect, it will be appreciated that the number of (child) output packets that will be produced in respect of an incoming set of work may be relatively larger, and that a given pipeline stage may therefore “amplify” the number of packets propagating within the processing pipeline.

For a (and each) (child) output packet to be produced/processed, the pipeline stage may then create a respective packet identifier identifying the (child) output packet, which packet identifier may then be provided for output, e.g., to pass the packet to a next processing stage (which next processing stage may, e.g., be a next pipeline stage in the sequence of pipeline stages, or could be a final processing stage that drains work (packets) from the processing pipeline). For instance, when the packet is provided to a next pipeline stage (i.e. the current pipeline stage is not the last pipeline stage), the packet identifier may then be added to the end of the work queue for the next pipeline stage.

The pipeline stage will also generate data for the (child) output packet(s) that it produces. In this respect, for each output packet to be produced/processed, the pipeline stage may be operable and configured to first allocate a respective portion of memory for storing (data for) the packet.

Once the memory has been allocated, the pipeline stage may further be operable and configured to trigger execution of a desired shader program for producing the data for the (child) output packet in question, which data will then be written to the allocated portion of memory.

A given pipeline stage may also be operable to trigger deallocation of memory that has previously been allocated (by a previous pipeline stage). For example, once a packet produced by one pipeline stage has been consumed, the data for that packet can be invalidated, and the portion of memory that was allocated for storing that data freed so that it is available to be allocated for new packets that are to be produced/processed.

The iterator circuit should therefore be, and in embodiments is, operable to support any and all of these processing operations.

For instance, various arrangements would be possible as to which processing operations will be performed when executing a particular pipeline stage, and in general the iterator circuit should therefore be able to support any and all of these processing operations in order to execute the different types of pipeline stages that may be supported by the processing pipeline in the technology described herein.

Further, as mentioned above, the iterator circuit should be generic, so that the different pipeline stages can all be supported by the same underlying processing circuits (logic) performing the same basic processing steps.

Thus, when executing a given pipeline stage, the iterator circuit is in embodiments operable and configured to perform some or all of the following (generic) processing steps in respect of an incoming packet of work that is to be processed by the pipeline stage in question (the iterator circuit may also perform other processing steps, as desired):
determining a corresponding output (child) packet to be produced by the pipeline stage;
allocating a portion of memory for storing an output (child) packet to be produced by the pipeline stage;
creating a packet identifier for an output (child) packet to be produced by the pipeline stage and providing the packet identifier for output to a next processing stage (which may, e.g., be a next pipeline stage within the processing pipeline, or may be a final processing stage that drains (primitive) packets from the processing pipeline);
issuing a shading request to trigger execution of a respective shader program (e.g. a compute shader) to be executed to produce data for a corresponding output (child) packet; and
deallocating a portion of memory that has previously been allocated for storing a packet for which the current pipeline stage is the last pipeline stage that will use the packet (i.e. where the packet is consumed by the current pipeline stage).

In embodiments, therefore, the iterator circuit is at least operable to perform any or all of these basic processing steps. The iterator circuit may of course also be operable to perform any other suitable processing steps that may desirably be performed to execute the pipeline stages.

As discussed above, however, which of these processing steps is actually performed for a given instance of pipeline stage execution, i.e. in respect of a given incoming packet of work, may depend on the particular work items within the packet for which processing is to be performed.

The effect and benefit of all of this is therefore to provide a more flexible approach for implementing such processing pipeline including a number of pipeline stages, in particular so that the same underlying processing circuits (e.g. hardware) can adaptively support different logical sequences of pipeline stages, including different numbers of pipeline stages, and in which the pipeline stages can be dynamically controlled to invoke different processing operations for different sets of work items that are received to be processed.

This can provide a particularly (silicon) area efficient approach for supporting different processing pipelines, so that the graphics processor is able to support more dynamic graphics processing flows (whilst still being able to support simpler graphics processing flows) using the same set of processing circuits.

For instance, in embodiments, the number of pipeline stages that are executed as part of the processing pipeline is configurable, and re-configurable, in use, and the set of processing circuits is controlled accordingly based on the particular sequence of pipeline stages to be executed.

For example, as mentioned above, the graphics processor comprises a set of work queues, wherein respective work queues within the set of work queues correspond to and identify packets of work to be processed for different, respective pipeline stages within the logical sequence of pipeline stages to be executed as part of the processing pipeline.

Thus, each pipeline stage that is to be executed will in embodiments have its own respective work queue that identifies the packets of work that are to be processed for that pipeline stage. The work queues may optionally also store other items, e.g. commands to update state, and/or trigger processing work, that may need to be processed for the pipeline stages.

The work queues for the different pipeline stages may generally be arranged and stored in any suitable and desired fashion.

In embodiments, however, the work queues correspond to respective partitions of a shared overall work ‘buffer’ that is available for use by the sequence of pipeline stages as a whole.

In particular, in embodiments, the graphics processor comprises, or has access to, appropriate storage in which such shared work buffer resides, and this shared work buffer is then partitioned, in use, into a set of work queues based on the number of pipeline stages to be executed so that each pipeline stage to be executed has its own partition/work queue.

In this respect it will be appreciated that in some instances the processing pipeline may only need to support a single pipeline stage, in which case there may only be a single work queue, and this is in embodiments handled in the same way described above (although in this case the pipeline manager operation may be simplified as there is then no need to arbitrate between multiple work queues).

The work buffer (and hence work queues) may generally reside in any suitable and desired stored that is accessible by the set of processing circuits that will execute the sequence of pipeline stages. For instance, in embodiments, the work buffer (and hence work queues) resides in storage that local to, and on chip with, the set of processing circuits that will execute the sequence of pipeline stages so that packets and other items can readily be provided from the work queues to the iterator circuit for processing.

In embodiments, the partitioning of the shared work buffer into the set of work queues is done as part of a configuration process for the processing pipeline. For instance, when a new processing job is received that will use the processing pipeline, before issuing any work to the processing pipeline, the processing pipeline may first be configured appropriately for the processing job in question.

Thus, the relevant pipeline configuration information for an incoming processing job, which pipeline configuration information will include the number of pipeline stages, etc., to be executed for the next instance of processing pipeline execution can be provided to the pipeline manager, and then used thereby to define/initialise the relevant pipeline configuration information for the next instance of processing pipeline execution. As part of this configuration process, the work buffer (and any other shared storage) is in embodiments partitioned accordingly based on the number of pipeline stages that are to be executed for the next instance of processing pipeline execution.

The partitioning of the shared work buffer into the set of work queues can be done in any suitable and desired manner, e.g. depending on how many, and which, pipeline stages are to be executed. For example, if the processing pipeline is configured to include a sequence of four pipeline stages, the work buffer is in embodiments then partitioned into four, in embodiments equal-sized, work queues, one for each pipeline stage. Thus, in embodiments, the partitions/work queues have equal sizes, so that each partition/work queue can store the same number of items. However, this is not necessary, and in some cases, the partitions/work queues may have different sizes, if appropriate/desired.

Various arrangements would be possible in this respect.

It will also be appreciated in this regard that the size of the work buffer may therefore place an effective upper limit on the number of pipeline stages that can be supported. In particular, in embodiments, to ensure progress can be made throughout the processing pipeline, the partition/work queue for each pipeline stage should contain at least one entry.

In that case, the number of entries within the work buffer may accordingly limit the number of pipeline stages that can be implemented. However, it will be appreciated that a single entry in a work queue (i.e. for identifying a single packet, command, etc.) will not require much storage space, and so in practice the shared work buffer may contain a relatively larger number of entries, and hence the graphics processor in the technology described herein can correspondingly support a relatively larger number of pipeline stages, without adding significant silicon area cost.

For example, in embodiments, the shared work buffer may contain N or more entries, and so the processing pipeline may correspondingly include up to N different pipeline stages that all be supported by the same processing circuits (i.e. rather than requiring N standalone processing circuits to support this). In this respect, the number of entries, N, within the shared work buffer may be at least 32 to be able to support work graphs having a maximum depth of 32, but the number of entries, N, could for example be 32, 64, 128 etc., so that the approach according to the technology described herein can readily scale to larger processing pipelines.

Thus, in embodiments, there is a shared work buffer that is partitioned, in use, into a set of work queues based on the number of pipeline stages to be executed.

The data flow through the processing pipeline is thus managed using the work queues, in particular by including respective identifiers for the packets of work to be processed into the respective work queues for the different pipeline stages, and the pipeline manager then selecting items (e.g. packets) from these work queues for processing.

In embodiments, to enforce ordering requirements within the processing pipeline, the pipeline manager when selecting items from the work queues is operable to always select items from the heads of the work queues (and correspondingly when items are provided for output from a given pipeline stage to a next pipeline stage, these items will be added to the tail of the work queue for the next pipeline stage). This then means that the items in the work queues in embodiments will remain in strict order as they propagate through the processing pipeline, which in turn means there may be no need to explicitly track the order of items within the processing pipeline.

Thus, in embodiments, the work queues operate in a ‘first-in-first-out’ (FIFO) manner to enforce a desired ordering between pipeline stages.

Other arrangements would however be possible.

Thus, if the next item that is selected for processing by the pipeline manager is a packet that is to be provided to the iterator circuit for processing, this is done, as discussed above. The iterator circuit may thus process the incoming set of work (packet), and produce a corresponding zero or more (child) output packets (although as will be described below, in embodiments, this is done over multiple processing cycles/iterations of the same set of work). These output packets may then be added to the work queue for the next pipeline stage in the sequence of pipeline stages (if there is one).

In this respect, it will be appreciated that a given pipeline stage may need to produce multiple output packets from an incoming packet of work. For instance, in general, an incoming packet may produce a larger number of output packets, with the number of output packets potentially being determined the processing of the incoming packet.

For example, in the context of a work graph, a set of one or more records contained within a packet may produce a respective output packet. A given packet may however contain plural separate records (or sets of records) for which different nodes of the work graph are to be executed, so that these records need to be separately processed.

Thus, a set of one or more records (or, generally, work items) within a packet may produce a respective output packet, but the packet may generally contain multiple such sets, that will each produce a respective output packet.

In general, therefore, a given pipeline stage may produce, for a single incoming set of work (e.g. a packet), multiple different output packets, and the number of output packets may depend on the packet of work that is being processed.

Further, because the iterator circuit is operable to generically process packets for different pipeline stages, it may not be known in advance of a particular instance of iterator processing how much memory will be needed for all of the processing that is to be performed for a given packet (as this will depend on the set of work (packet), in question).

In view of this, in embodiments, the iterator circuit is therefore configured to (only) produce one output packet at a time (per processing cycle).

Thus, when the pipeline manager selects a packet of work to be processed by the iterator circuit, the iterator circuit when processing that packet of work is configured to only produce a single output packet (per processing cycle).

Accordingly, when multiple output packets are to be produced from an incoming packet of work, that same packet should be, and in embodiments therefore is, provided by the pipeline manager to the iterator circuit a corresponding multiple number of times, in order to produce the desired number of output packets.

For example, in the context of a work graph, the iterator circuit will in embodiments process a set of one or more records at a time (per processing cycle), for which set of one or more records a particular node is to be executed (and in embodiments the iterator circuit processes only a single record at a time). Thus, if an incoming packet of work to a pipeline stage contains multiple records that are to be processed separately, the same packet of work should be processed a corresponding multiple number of times to process all of the records to produce the desired output packets.

That is, rather than the pipeline manager sending the packet to the iterator circuit once, and the iterator circuit then iterating over that packet multiple times in succession to produce all of the required output packets, in embodiments, the same packet will be provided by the pipeline manager to the iterator circuit, and processed thereby, multiple times until all of the iterations to produce the required number of output packets have completed. This also means that the iterations over a particular incoming packet of work need not be performed successively, as the pipeline manager may also select items from other work queues between iterations.

To manage this, therefore, it is in embodiments also tracked, for a (and each) packet of work that is provided to the iterator circuit for processing, how many times that particular same packet has been processed by the iterator circuit. This so-called ‘iteration’ state can therefore be updated by the iterator circuit each time the (same) packet of work is processed and used by the pipeline manager to control how many times that packet is provided to the iterator circuit for processing.

For instance, for a (and each) packet of work, it can also be determined how many times the packet of work should be processed, i.e. based on the pipeline stage, and/or the work items within the packet, in question. The pipeline manager can thus use the ‘iteration’ state to determine whether and when the packet of work has been processed the correct number of times. The iteration state therefore in embodiments tracks, for respective pipeline stages, the number of iterations that have been performed for the current packet of work that is being processed by the respective pipeline stages. Accordingly, when a new packet of work for a particular pipeline stage is issued to the iterator circuit for processing, once this processing has completed, the number of iterations for that packet of work will be incremented by one, and the iteration state updated accordingly. So long as the number of iterations that have been performed is less than the number of iterations that should be performed for that packet of work, the packet will however remain in the work queue for the current pipeline stage, and so will eventually be selected again for processing. Only once the final iteration has been performed, i.e. such that the number of iterations that have been performed is equal to the number of iterations that should be performed, is the packet of work removed from the work queue for the current pipeline stage.

Thus, in embodiments, the iterator circuit is operable and configured to produce one output packet per processing cycle. In that case, when a pipeline stage within the sequence of pipeline stages to be executed as part of the processing pipeline is to produce a plurality of output packets from a single incoming packet of work, the pipeline manager may be operable and configured to provide the same packet of work to the iterator circuit for processing a corresponding plurality of times to produce the plurality of output packets.

An incoming packet of work to be processed by a particular pipeline stage will thus in embodiments remain in the respective work queue for that pipeline stage until the set of work has been processed enough times to produce all of the output packets that are to be produced from that same packet of work, and to facilitate this the pipeline manager is in embodiments operable and configured to track how many times a same, single packet has been processed by the iterator circuit in respect of a particular pipeline stage. The pipeline manager will thus cause the packet of work to remain in its current work queue until the last iteration of that set of work has been performed, at which point the packet can be removed from its current work queue.

In some cases, when a packet of work is provided to the iterator circuit for processing, the iterator circuit may not be able to perform the desired processing. A typical example of this would be when the memory allocation fails since there is not enough free memory that can be allocated for a corresponding output packet. In such cases, the iterator circuit may thus signal to the pipeline manager that the processing has failed, and this will cause the packet of work to remain in the work queue for the current pipeline stage. The pipeline manager will accordingly, at some point, select that packet of work for processing again, and provide the set of work to the iterator circuit again to re-try the processing.

It will be appreciated however that if a memory allocation has failed, the memory allocation will likely continue to fail until sufficient progress has been made elsewhere within the processing pipeline to cause some memory to be deallocated.

In embodiments, therefore, in the event that a memory allocation fails for a given packet of work, the pipeline manager tries to avoid re-selecting that packet of work until it is determined that there is free memory. To do this, in embodiments, in the event that a memory allocation fails for a packet, the iterator circuit signals this to the pipeline manager, and a corresponding indication (e.g. a flag) associated with the packet is set accordingly to indicate that the memory allocation has failed. This indication may, for example, be stored within the work queue in association with the entry for and identifying that packet.

When this indication is set, the pipeline manager when selecting a next item to be processed, may then ignore that entry, and preferentially select a different item, i.e. from a different work queue, for processing.

Thus, in embodiments, the iterator circuit when executing a particular pipeline stage to process a packet of work is operable to allocate a portion of memory for storing a corresponding output packet that will be produced from the incoming packet of work, and wherein when the memory allocation fails, the packet remains in the respective work queue for the particular pipeline stage being executed so that the pipeline manager can subsequently re-select that packet for re-processing.

Further, in response to a memory allocation for a packet of work failing, a respective indicator associated with the packet of work may be set accordingly to indicate that the memory allocation has failed, and the pipeline manager may then be controlled to not re-select that packet for processing until the indicator has been reset to indicate that the processing should be re-tried.

For example, in embodiments, once the indicator (e.g. flag) has been set to indicate that the memory allocation has failed, the indicator may subsequently then be reset, or cleared, in response to a portion of the memory into which the memory allocation was requested being deallocated. That is, the indicator may be reset following a successful memory deallocation event that frees up a portion of the memory into which the allocation is to be performed. At that point, the packet of work will therefore be available for selection, and at some point, will be selected again by the pipeline manager for processing, at which point it will be provided again to the iterator circuit, and the memory allocation should now be successful (as there is now available memory that can be allocated).

In some embodiments the indicator may also be reset under other conditions, e.g. based on a time out condition, to allow the processing to be tried again even if no memory deallocation has been made. This may be appropriate to provide a failsafe operation. For instance, the memory allocation could have failed due to some transient error, rather than a lack of available memory, and so it may be desirable to (eventually) try the processing again even without waiting for a successful memory deallocation event.

Various arrangements would be possible in this regard.

Thus, the arbitration scheme that is used by the pipeline manager to select which item is to be next processed may, and in embodiments does, consider such indication when making this selection. Otherwise, the arbitration scheme that is used by the pipeline manager to select which item is to be next processed may take any suitable form and may also consider any desired system conditions.

For example, in embodiments, this could involve a round-robin process where, so long as there is valid data available to be selected in the work queues, the pipeline manager selects items from the heads of each work queue in turn.

Other arrangements would however be possible and in general the arbitration scheme that is used by the pipeline manager to select which item is to be next processed may be more or less complex/intelligent, as desired.

As discussed above, a given pipeline stage may generally invoke any suitable and desired processing to process a given set of one or more work items (to produce a corresponding output packet). Typically, however, and in embodiments, a shader program should then be executed to process the packet to produce the desired output data.

In this regard, the graphics processor will have a set of, typically plural, shader cores/execution engines that are operable to execute shader programs.

The graphics processor may include any suitable and desired arrangement of shader cores. Thus, the set of shader cores can be any suitable and desired set of shader cores that is operable to execute shader programs.

The set of shader cores may comprise a single shader core but in embodiments includes plural shader cores. Where there are plural shader cores, each shader core may be operable to execute shader programs in a similar manner. The (and each) shader core should, and in an embodiment does, comprise appropriate circuits (processing circuits/logic) for performing the operations required of the shader core. Where there are plural shader cores, each shader core may be provided as a separate circuit to other shader cores of the graphics processor, or the shader cores may share some or all of their circuits (circuit elements).

Various arrangements would be possible in this regard.

The iterator circuit thus in embodiments has a respective shading interface via which it can submit shading requests to the graphics processor's set of shader cores (with this shading interface also being ‘generic’ in that the iterator circuit can invoke different shader programs, as needed, depending on the set of work items being processed).

Such (generic) shading requests may, for example, be issued to a general purpose (e.g. “compute”) shader endpoint that is operable to trigger the specified shader program(s). Other arrangements would however be possible.

These shading requests will in embodiments also specify the respective shader program or shader programs that are to be executed.

That is, when the iterator circuit issues a shader request to the graphics processor's set of shader cores, the shading request should therefore, and in embodiments does, also include an indication of which shader program (or programs) are to be executed. The shader program may be indicated relative to a preconfigured ‘shader binding table’, for example, that includes a list of available shader programs.

Various other arrangements would however be possible in this regard.

The shading request should also, and in embodiments does, indicate one or more memory locations containing the (input) packet(s) to be processed and/or for writing the (output) results. It will be appreciated that this is also done ‘generically’, such that the set of shader cores simply receives indications of (e.g. pointers to) input/output memory locations to be used, and these memory locations can include any desired packets to be processed, but the set of shader cores does not necessarily know which pipeline stages those packets relate to. This can therefore again increase flexibility/configurability of the processing pipeline.

After the required packet processing (e.g. shading) has been performed for a given packet of work items being produced, the processed (shaded) output can be written to the respective portion of memory that was allocated for that packet, and the packet can be marked as complete, so that the packet is made available for output, e.g. to a next pipeline stage in the processing pipeline (or otherwise, e.g. if the current pipeline stage is the last pipeline stage), and subsequently output from the pipeline stage as appropriate, e.g. for further processing.

For example, and in embodiments, for each (child) output packet, a respective packet identifier identifying that packet is provided for output to the next pipeline stage, e.g. wherein the packet identifier will be added to the end of the work queue for the next pipeline stage, so that the packet can be processed accordingly by the next pipeline stage once the required packet processing (e.g. shading) has been performed.

The identifiers that are stored within the work queues may thus identify the packets of work to be processed, and contain any other information that may be needed by the pipeline manager to process and identify the packet.

These identifiers can thus be used to track work between the different pipeline stages. The identifiers that are stored within the work queues, in addition to identifying the respective packets of work to be processed, may also contain information needed by the iterator circuit to perform its processing. Alternatively, or additionally, some or all of this information may be stored in memory (i.e. alongside the packet payload data), and suitably fetched when the packet is provided to the iterator circuit for processing.

Various arrangements would be possible in this regard.

It will be appreciated that when executing a processing pipeline in which a stage or stages of the pipeline generate data for use by later stage(s) of the pipeline, there may be a need for the data generated by the stage(s) to be stored for subsequent use by other pipeline stage(s), and for those other pipeline stage(s) to be able to access that data appropriately.

For a packet of work items that is to be further processed within the pipeline stage (e.g., and in particular, for each “child” output packet to be produced), the iterator circuit is in embodiments then operable to allocate, for the packet, a respective portion of memory for (temporarily) storing data for that packet.

The memory that is available for storing (data for) packets can generally be any suitable and desired memory and can be configured in various ways. In embodiments, however, the memory that can be allocated for storing (data for) packets is portioned into a plurality of memory “pools”, each memory pool being associated with one or more pipeline stages. This can then help with memory management, in particular managing data dependencies between pipeline stages.

A given pipeline stage may therefore be associated with at least one memory pool that it is able to allocate portions of for temporarily storing data for packets of work items that are to be processed within that pipeline stage.

In embodiments, each pipeline stage other than the (final) (primitive) packet draining stage, where this is present, has an associated memory pool from which it can allocate respective portions for temporarily storing data for packets of work items that are to be processed within that pipeline stage.

Various arrangements would be possible in this regard.

A given (generic) pipeline stage may thus allocate respective portions of its memory pool for respective packets that are processed/generated within that pipeline stage. There may, however, then be one or more other, later pipeline stages that also potentially need to access (data for) packets that were generated/processed by an earlier pipeline stage. That is, data generated by a particular, earlier pipeline stage in respect of a packet may also be required as input for the processing of corresponding (child) packets in certain, later pipeline stages. Such later pipeline stages should therefore, and in embodiments do, also have access to any memory pools storing data that may be needed by such later pipeline stages. Such later pipeline stages can in embodiments also update the data within such memory pools, but cannot perform new allocations within such memory pools.

This memory (pool) assignment is in embodiments performed in advance during an initial configuration of the processing pipeline. That is, when the processing pipeline is being configured, a set of memory pools are in embodiments configured, and appropriate access permissions are set for each of the pipeline stages to the respective memory pools. For example, a suitable indicator of which pipeline stages can access which memory pools can be generated during the initial pipeline configuration. This indicator may, e.g., take the form of a ‘bit mask’ per memory pool indicating which pipeline stages can access that memory pool, but other arrangements would of course be possible.

Thus, the access permissions may be flexibly re-configured for different instances of executing the processing pipeline, but should be, and in embodiments therefore are, fixed for a particular instance (or set of instances) of the processing pipeline.

The first pipeline stage that can access a given memory pool is thus permitted to allocate portions of that memory pool (and it is in embodiments only the first pipeline stage that is permitted to allocate portions of the memory pool). Any other pipeline stages that are permitted to access the memory pool are thus in embodiments able to read data from, and in embodiments also update data within, the memory pool, but are in embodiments unable to allocate portions of the memory pool (and instead, those pipeline stages may, and typically will, be associated with another, separate memory pool from which they can allocate portions for work items being processed/generated by those pipeline stages).

As mentioned above, there is in embodiments a shared memory management system that is operable and configured to then manage any accesses to the memory pools by the pipeline stages (and enforce such access permissions).

The memory pools that are available and associated with the different (generic) pipeline stages may reside in any suitable and desired memory accessible by the graphics processor. For instance, in embodiments, the memory pools from which the (generic) pipeline stages are able to allocate respective portions of may be partitioned from within an overall memory buffer (which may, e.g., be referred to as a geometry buffer in the case where the processing pipeline is to perform geometry processing, but in general the buffer may be used to store any temporary items that are produced and consumed by execution of the pipeline stages).

Various arrangements are however contemplated in this regard.

The (data generated for) packets of work items being processed by a particular pipeline stage can thus be written to the associated memory pool for that pipeline stage (i.e. the memory pool from which that pipeline stage can allocate respective portions). For example, as mentioned above, for a (child) packet of work items that is to be further processed within a particular pipeline stage, a respective portion of the associated memory pool for that pipeline stage can be temporarily allocated for use by that packet, as required. A suitable packet identifier (e.g. included within a packet header) can thus be written to the allocated portion of the associated memory pool to reserve that portion. Any data (elements) generated for a packet can then be written to the respective portion of the memory pool that has been allocated for that packet during the processing of the packet.

Further, the data (elements) generated for a packet, and stored in a respective portion of a memory pool, can then be read from, and in embodiments also updated by, subsequent pipeline stages, as needed.

The initial assignment of the memory (pools) to the (generic) pipeline stages, and setting of the relevant access permissions, during the overall pipeline configuration thus controls and facilitates the data flow along the processing pipeline. For example, even when different (logical) pipeline stages share the same underlying physical circuits, different (generic) pipeline stages in embodiments have respective, different memory pool ‘carveouts’ from which they can allocate respective portions of for temporarily storing data (elements) generated for packets it is processing (with other pipeline stages potentially being permitted to read/update data from that memory pool, as appropriate based on the pipeline configuration, but being prohibited from allocating portions of that memory pool (and instead having their own associated memory pool from which they can allocate portions for temporarily storing data (elements) generated for packets being processed by those pipeline stages).

The above describes the main elements and operation of the graphics processor and processing pipeline that are relevant to operation in the manner of the technology described herein.

The technology described herein can be used for all forms of output that a graphics processor and processing pipeline may be used to generate. In particular, the technology described herein may be used both for generating graphics processing outputs, such as frames for display, render to texture outputs, etc., or for general purpose (non-graphics) outputs.

As will be appreciated by those skilled in the art, the graphics processor can otherwise include and execute, and in embodiments does include and execute, any one or one or more, and in embodiments all, of the pipeline stages and circuits that graphics processors and processing pipelines may (normally) include.

For example, the graphics processor may include a geometry processing pipeline that processes raw geometry that has been application-defined for a particular graphics processing operation into a suitable, e.g. screen-space, format version of that geometry for subsequent rendering of the geometry to produce a desired output (e.g. an image or other output).

To do this, the graphics processor may execute a processing pipeline that includes one or more geometry pipeline stages, such as vertex shading, task shading, mesh shading, tessellation shading, etc., and/or may execute a processing pipeline to execute a suitable work graph that performs some or all of the desired geometry processing. Various arrangements would be possible in this regard and a benefit of the technology described herein is that it can support various processing flows, including more dynamic processing flows, that may be used to execute any suitable and desired processing (which could therefore be geometry-related processing, but may also be other suitable graphics or non-graphics processing, as desired).

As discussed above, the processing pipeline according to the technology described herein includes a certain logical sequence of pipeline stages that can be, and is, implemented using a set of (generic) processing circuits that are effectively shared between the different pipeline stages. This set of (generic) processing circuits will include a iterator circuit, a set of work queues and a pipeline manager, as discussed above, and will have access to various shared storage. The logical sequence of pipeline stages that is executed using the set of (generic) processing circuits according to the technology described herein in embodiments comprises a sequence of shader stages, as discussed above.

However, subject to this, the overall processing pipeline may generally contain any suitable and desired pipeline stages and so could also, and in some embodiments does, include one or more other pipeline stages, as appropriate, which other pipeline stages may perform any other suitable processing operations, as desired, and may or may not be implemented using the same set of (generic) processing circuits that execute the pipeline (shader) stages.

For instance, ‘other’ pipeline stages might suitably be provided as a first and/or last pipeline stage in the processing pipeline that either provides packets to the (generic) pipeline stages or drains primitive packets therefrom, which might therefore desirably operate in a different manner to the intermediate pipeline stages, and various arrangements would be possible in this regard.

In this respect, embodiments relate to tile-based graphics processing including a binning stage that sorts geometry relative to the tiles. In that case, geometry processing may be performed prior to the binning stage to generate respective (geometry) packets, each containing data for geometry to be processed. The binning stage then generates a data structure or structures to allow the packets storing data for geometry that apply to respective rendering tiles to be identified.

In embodiments the graphics processor may also execute one or more rendering stages, such as rasterization and fragment shading stages, and/or appropriate ray tracing stages. In an embodiment the graphics processor is in the form of a tile-based graphics processor and so also includes and executes an appropriate tiling/binning stage or stages.

Correspondingly, the graphics processor may include any one or more of, and in embodiments plural of: one or more geometry processing circuits, primitive assembly circuit or circuits, a tiling/binning circuit or circuits, a primitive setup circuit, a rasteriser circuit and a renderer circuit (in embodiments in the form of or including a programmable fragment shader), a depth (or depth and stencil) tester, a blender, a tile buffer, a write out circuit, etc..

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus, it may comprise, for example, a tile to be generated in a tile-based graphics processing system, and/or a frame of output fragment data. The technology described herein can be used for all forms of output that a graphics processor and processing pipeline may be used to generate, such as frames for display, render-to-texture outputs, etc.. In an embodiment, the output is an output frame, and in embodiments an image. However, in general the graphics processors (and processing pipelines) of the technology described herein may be used both for performing graphics processing work, such as generating frames for display, etc., or for performing general purpose (non-graphics) work, as desired.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, and stages, of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various pipeline stages may share processing circuitry/circuits, etc., if desired.

Furthermore, unless otherwise indicated, any one or more or all of the pipeline stages of the technology described herein may be embodied as pipeline stage circuits, e.g., in the form of one or more fixed-function units (hardware) (processing circuits), and/or in the form of programmable processing circuits that can be programmed to perform the desired operation. Equally, any one or more of the pipeline stages and pipeline stage circuitry of the technology described herein may be provided as a separate circuit element to any one or more of the other pipeline stages or pipeline stage circuits, and/or any one or more or all of the pipeline stages and pipeline stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

Embodiments of the technology described herein will now be described.

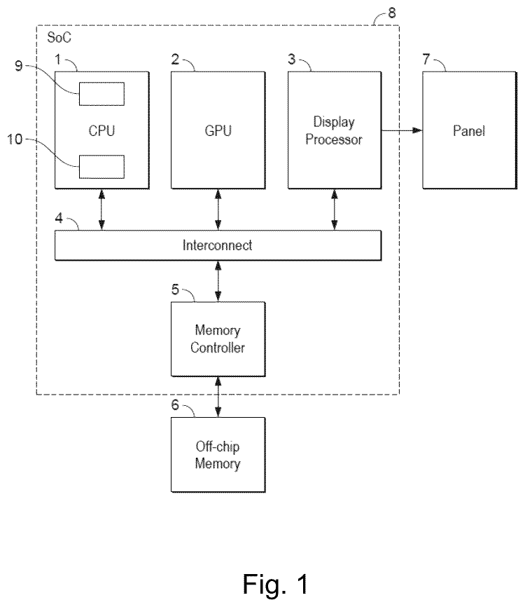

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

The graphics processor 2 may operate to execute a graphics processing pipeline that processes graphics primitives, such as triangles, when generating an output, such as an image for display.

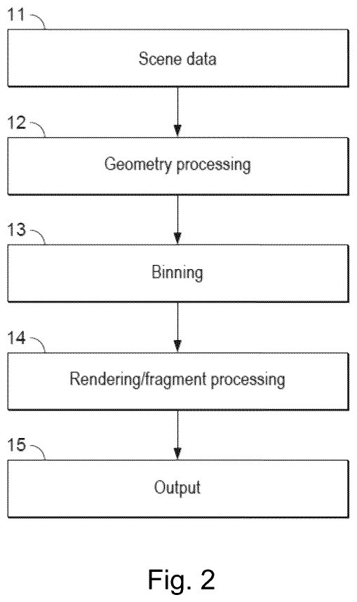

FIG. 2 shows schematically a processing sequence of a graphics processing pipeline that may be executed by the graphics processor 2 when generating an output according to an example.

FIG. 2 shows the main elements and pipeline stages of a particular graphics processing pipeline. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry pipeline stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the example shown in FIG. 2, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. The vertex shading may also comprise generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the example shown in FIG. 2, a binning/tiling stage 13. (It is assumed in this regard that the graphics processor 2 in this example is a tile-based graphics processor and so generates respective output tiles of an overall output (e.g. frame) to be generated separately to each other, with the set of tiles for the overall output then being appropriately combined to provide the final, overall output.)

The binning/tiling process 13 operates to generate appropriate data structures for determining which primitives need to be processed for respective rendering tiles of the output being generated.

For example, the binning/tiling process 13 may sort the primitives into appropriate primitive lists, which indicate the primitives to be processed for respective tiles or sets of tiles. Alternatively, the binning/tiling process 13 may generate other data structures, such as hierarchies of bounding boxes, that can then be used at the rendering/fragment pipeline stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process 13 has generated the necessary data structures for identifying the primitives to be processed for respective tiles of the render output, the primitives can then be and are then subjected to appropriate rendering/fragment processing 14. This operation may, for example, be performed on a tile-by-tile basis, using the data structures generated by the tiling/binning process 13 to identify those primitives that need to be processed for a respective tile.

The rendering/fragment processing 14 can comprise any suitable and desired rendering and fragment processing operations that may be performed. Thus, it may comprise, for example, first rasterising primitives to be processed for a tile to fragments, and then processing those fragments accordingly (e.g., and in embodiments, by performing appropriate fragment shading of the fragments). The rendering/fragment processing 14 may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing 14 (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc..

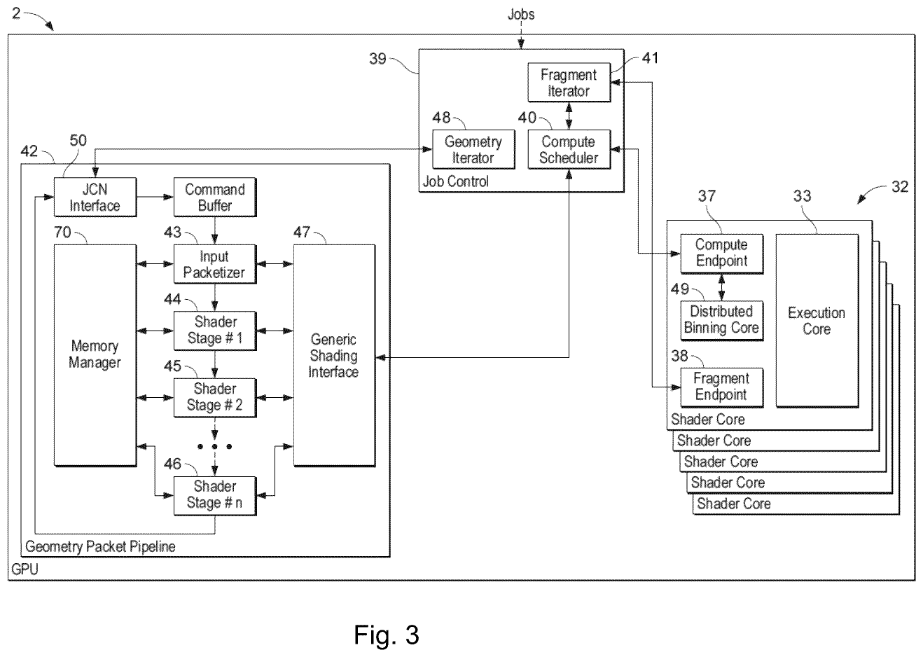

FIG. 3 shows an embodiment of a graphics processor (GPU) 2 that can execute a graphics processing pipeline of the form shown in FIG. 2, and that can generally be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

Each execution core 33 has appropriate access to a memory system 6 of the data processing system that the graphics processor 2 is part of.

The shader cores 32 are operable to execute both “compute” shader programs (to perform so-called compute shading) and fragment shader operations. Thus, as shown in FIG. 3, each shader core 32 comprises an appropriate compute endpoint 37 and fragment endpoint 38 that act as the control interface for performing compute shading and fragment processing, respectively, and that will, for example, and in embodiments, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will often be an initial geometry processing pipeline stage that determines the vertex and other data that is necessary for generating the graphics processing output in question, which will then be followed by a rendering/fragment pipeline for processing (rendering) that geometry.

The initial geometry processing can be performed, as shown in FIG. 3, by a geometry packet pipeline 42 of the graphics processor 2, which geometry packet pipeline 42 is operable to trigger the performance of one or more “geometry” pipeline stages (which pipeline stages themselves will be executed by the shader cores 32, under the control of the geometry packet pipeline 42).

For example, as shown in FIG. 3, the geometry packet pipeline 42 may comprise an input packetizer 43 that can trigger position shading and vertex shading by the shader cores 32. It also includes further pipeline stages 44, 45, 46 that are operable to trigger compute shaders (shader programs) for performing geometry processing, such as task shaders, mesh shaders, tessellation shaders, etc., (which shaders again will be executed by the shader cores 32).

As shown in FIG. 3, the geometry packet pipeline 42 thus has an appropriate interface, in the form of shading manager 47, to the compute scheduler 40 of the job control unit 39, via which it can control and trigger the performance of appropriate geometry shading operations by the shader cores 32.

The geometry packet pipeline 42 also has an appropriate interface, in the form of memory manager 70, to the memory system 6, in which appropriate storage is allocated for storing the geometry packets that will be produced and processed by the geometry packet pipeline 42 (although this off-chip memory 6 will typically be accessed via a cache system, such that at least some packets may be held entirely locally to, and on-chip with, the graphics processor 2 in use, without ever being written out to the off-chip memory 6). The geometry packet pipeline 42 thus also has a shared memory manager 70 which manages the memory allocations and deallocations for temporary packet data for each of the pipeline stages.

In general, any suitable memory may be used to support the geometry packet pipeline 42. In the present embodiments, however, this memory is in the form of a set of memory pools, with respective memory pools being assigned to respective, different pipeline stages within the geometry packet pipeline 42.

Thus, for instance, different pipeline stages may be allocated different portions within an overall, shared geometry buffer that is backed by the off-chip memory system 6.

When a pipeline stage is processing a packet input to that pipeline stage, depending on the pipeline stage in question, the pipeline stage may accordingly allocate a respective portion of memory for storing the output packet(s) that will be produced by the processing of the packet.

In this respect, a given pipeline stage may only allocate memory within the respective memory pool assigned to that stage (and, typically, only one pipeline stage is able to allocate within a given memory pool, although other pipeline stages may still access the data within that memory pool).

For example, the first pipeline stage accessing a given memory pool may always allocate packets to that memory pool. Correspondingly, the last pipeline stage accessing a given memory pool is then operable to trigger de-allocation of packets for that memory pool. Any intermediate pipeline stages can only access the memory pool, e.g. by reading and/or writing an already allocated packet (but cannot perform any memory allocations/de-allocations).

Each pipeline stage also maintains a packet queue storing packet identifiers, in the form of packet “headers” identifying the packets to be processed (and the location of the payload data for those packets). The packet queue is operated in a ‘first-in-first-out’ (FIFO) manner so that packets are kept strictly in the order the associated packet payloads were allocated. Since allocations and deallocations in the memory pool should always happen in order, this then avoids any need to track individual allocations.

The overall operation of the geometry packet pipeline 42 is controlled, and triggered, by the job control unit 39 (by a geometry iterator 48 of the job control unit 39) which distributes the appropriate geometry processing jobs and tasks to the geometry packet pipeline 42. The geometry packet pipeline 42 will thus have a respective interface 50 to the job control unit 39 via which commands and status updates can be signalled.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated (i.e. to implement the binning/tiling process 13).

In the present embodiments, the distributed binning cores 49 generate hierarchies of bounding boxes for primitives and primitive packets (that contain primitives to be rendered) (which are then used at the rendering/fragment pipeline stage 14 to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

As shown in FIG. 3, the distributed binning cores 49 of the shader cores 32 may also trigger compute shading, via the compute endpoint 37. For example, the distributed binning cores 49 of the shader cores 32 may in some instances trigger some or all of the vertex shading, such as varying shading, as part of their operation (e.g., and in particular, where varying shading was not performed by the input packetizer as part of the input packetizer 43 operation).

Various arrangements would be possible in this regard.

In the present embodiments, the rendering/fragment processing 14 will be performed by executing appropriate fragment processing operations on a shader core 32 under the control of the fragment frontend 38. To facilitate this, as shown in FIG. 3, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes (which data can be respectively considered to be corresponding data elements (e.g. positions or varyings, in the case of vertices) for corresponding work items (e.g. vertices)), which data will then be used, for example, by the binning/tiling processing 13 and rendering/fragment processing 14 of the later stages of the graphics processing pipeline.

In this respect, the geometry packet pipeline 42 may in the above example operate to generate respective geometry packets containing the data that it generates. Those geometry packets are then processed by the distributed binning cores 49 to generate corresponding primitive packets, which primitive packets are then used by the fragment processing (fragment shaders).

Thus, in the example described above, the geometry packet pipeline 42 will generate work item packets, in the form of geometry packets, that store data elements (attributes) for work items (such as vertices and primitives), which geometry packets will then be read and used by the distributed binning cores 49. Correspondingly, the distributed binning cores 49 will generate appropriate primitive packets storing data elements (attributes) for work items, such as vertices and primitives, which primitive packets will then be read and used by the fragment processing 38.

Various other arrangements would of course be possible. For example, rather than the geometry packet pipeline 42 generating geometry packets that are then read and used by the distributed binning cores 49 as shown in FIG. 3, the geometry packet pipeline 42 could interface and provide geometry packets to a tiling unit that then performs more traditional tiling operations, e.g. in the normal (serialized) manner for tile-based graphics processing, using the geometry packets.

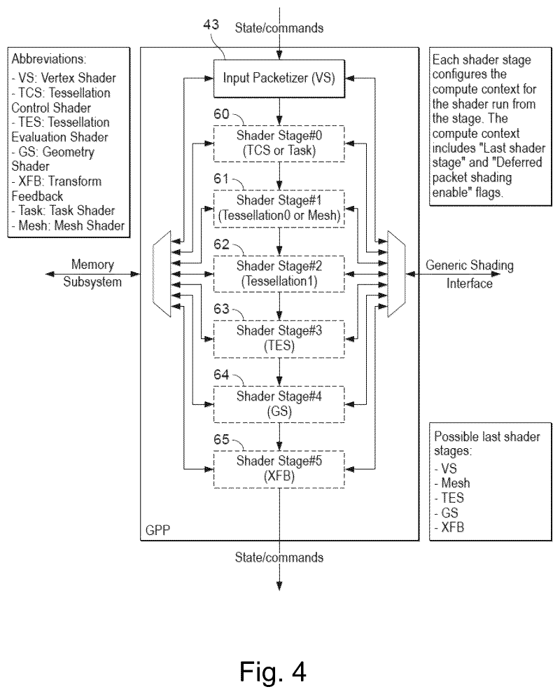

FIG. 4 shows in more detail one possible example of a geometry packet pipeline 42 that may be executed by the graphics processor.

In particular, in the example shown in FIG. 4, the geometry packet pipeline 42 comprises (can trigger the execution of) a sequence of six pipeline stages, an input packetizer 43 (can trigger vertex shading (VS)) a next pipeline stage 60 that can trigger tessellation control shading or task shading, a next pipeline stage 61 that can trigger tessellation shading or mesh shading, a next pipeline stage 62 that can trigger further tessellation shading, a next stage or stage 63 that can trigger tessellation evaluation shading, a next stage or stage 64 that can trigger geometry shading, and a final pipeline stage 65, that can trigger transformed feedback shading.

In this example, the input packetizer 43 reads the index array and builds packets that can be used by the rest of the pipeline.

Thus, in the present example, the only shading that can be (and is) invoked by the input packetizer 43 is vertex shading (which can be position-only vertex shading or combined position and varyings shading). The input packetizer 43 can also be selectively disabled and/or enabled without shading and populated with (pre-shaded) input vertices, depending on the particular processing operations to be performed.

Once a packet has been fully populated by the input packetizer 43 (when this is done), the packet is sent to the next stage in the geometry processing pipeline 42 which then processes the incoming packet, and triggers any desired shader execution, e.g. as described above.

In operation, each pipeline stage of the geometry packet pipeline 42 will configure the compute context for the shader that is run from the stage in question (with this compute context being signalled to the compute scheduler 40 accordingly via the shading manager 47).

Thus, as described above, the geometry processing pipeline 42 further includes a plurality of pipeline stages 60-61-62-63-64-65 that can be, and are, dynamically configured in advance of geometry processing pipeline 42 execution as respective pipeline stages to perform the desired pipeline operations.

Various arrangements would be possible in this regard.

FIG. 4 thus illustrates the logical data flow according to the geometry packet pipeline 42 in this example.

As shown in FIG. 4, there will be a certain sequence of pipeline stages to be executed within the geometry packet pipeline 42.

However, as will be explained further below, rather than providing dedicated hardware circuitry to support a particular configuration of the geometry packet pipeline 42, some or all of the pipeline stages that are to be executed as part of the geometry processing pipeline 42 can be executed using a set of shared processing circuitry (hardware).

This then means that any or all of the pipeline stages 60-61-62-63-64-65 may be implemented generically in hardware with the same set of shared processing circuits. The processing circuits are then controlled based on suitable software configuration to perform appropriate processing operations to execute the various different pipeline stages.

That is, although the various pipeline stages 60-61-62-63-64-65 are depicted in FIG. 4 as separate stages, and at least from a logical perspective are treated as separate stages defining the geometry packet pipeline 42, the pipeline stages 60-61-62-63-64-65 can be executed using a shared set of shared physical processing circuits, with those processing circuits being controlled to execute different pipeline stages, as desired, and with the data flow between pipeline stages thus being managed appropriately, e.g. using respective packet queues and memory pool allocations, as will be explained further below.

When work is to be performed using the geometry packet pipeline 42, this can thus be triggered by issuing a suitable command to the geometry processing pipeline 42, and such command will cause work to be launched on the first enabled stage in the geometry processing pipeline 42. This first stage may be the input packetizer 43 or a subsequent pipeline stage depending on the particular operations to be performed (e.g., and in particular, whether the input packetizer 43 is present/enabled).

The first pipeline stage may then request from the memory manager 70 to allocate a packet in a respective memory pool tied to the first pipeline stage. If allocation succeeds, the first stage then issues a shading request via its generic shading interface 47 in respect of the packet to the compute scheduler 40 within the job control unit 39 of the graphics processor 2, which compute scheduler 40 then schedules a corresponding one or more processing tasks to respective compute endpoints 37 of the shader cores 32. The shader program run on the packets issued by a particular stage is in this example defined by a unique shader program descriptor for the stage, which may be configured as part of the initial pipeline configuration.

Consecutive packets issued for shading are thus distributed to available shader cores 32 in this way with the packet shading being controlled via the compute shader scheduler 40 (and compute endpoints 37).

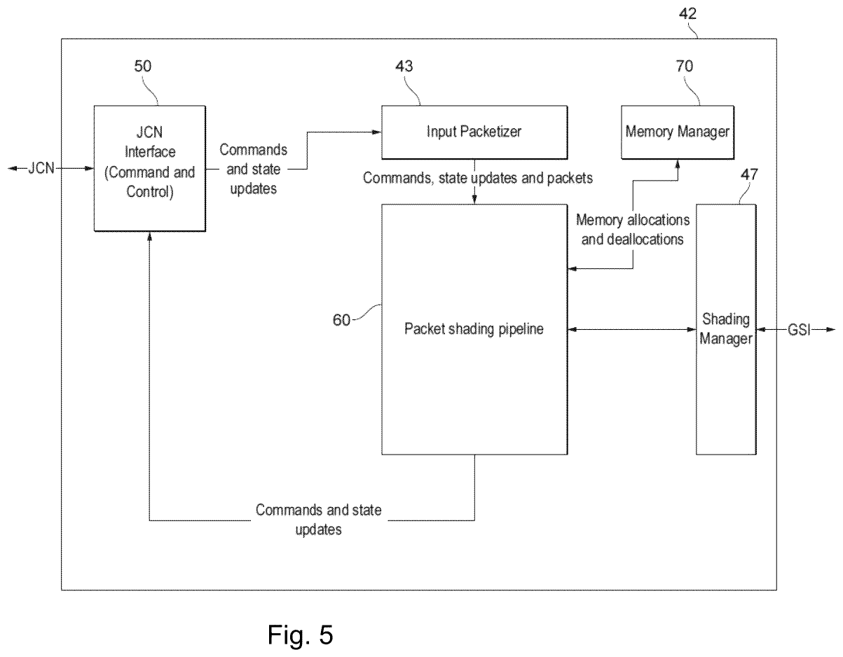

FIG. 5 shows a simplified high-level view of the geometry packet pipeline 42 described above to illustrate how the geometry packet pipeline 42 of the above example may be supported in hardware.

In particular, in this example, plural pipeline stages, which pipeline stages are denoted in FIG. 5 as the packet shading pipeline 60, are all executed using a set of shared processing circuits (hardware). The processing circuitry that executes the packet shading pipeline 60 thus contains suitable processing logic to execute the required pipeline stages within the packet shading pipeline 60. This processing circuit also interfaces with the other stages within the geometry packet pipeline 42, as appropriate. For instance, as shown in FIG. 5, the packet shading pipeline 60 is operable to communicate with (and receive packets) from the input packetizer 43 (if present/enabled), and to communicate with the memory manager 70 and shading manager 47 as part of its execution of the different pipeline stages to be executed.

As shown in FIG. 5, the packet shading pipeline 60 is also operable to communicate with the job control network interface 50 via which geometry processing work is submitted to the geometry packet pipeline 42 (from the geometry iterator 48). The packet shading pipeline 60 may for example signal commands and state updates back to the job control network interface 50.

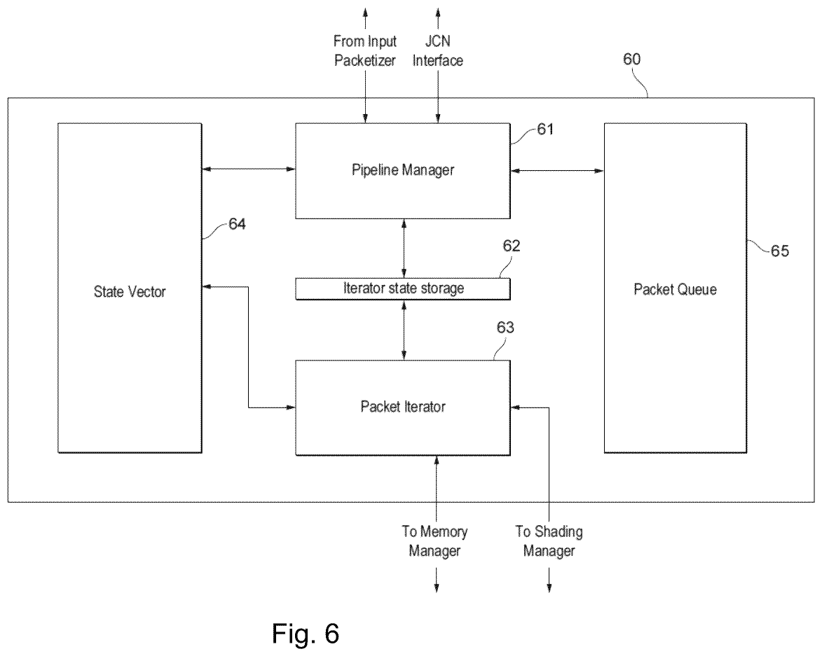

FIG. 6 shows in more detail the processing logic to execute the different pipeline stages within the packet shading pipeline 60.

As shown in FIG. 6, the packet shading pipeline 60 has access to a work buffer, in the form of shared packet queue 65, which is a shared resource that stores the packets for each of the different pipeline stages within the packet shading pipeline 60.

In this regard, it will be appreciated that the number of pipeline stages within the packet shading pipeline 60 is configurable, and so the number of pipeline stages configured within the packet shading pipeline 60 may change over time.

Thus, as shown in FIG. 6, the shared packet pipeline 60 is executed using an iterator circuit, in the form of packet iterator 63, that, as will be explained further below, is operable to control the processing of packets for each and any of the different pipeline stages to be executed as part of the packet shading pipeline 60.

To manage this operation, there is further provided a pipeline manager 61 that is operable to provide packets from the shared packet queue 65 to the packet iterator 63 for processing.

Although FIG. 6 shows only a single packet iterator 63 and pipeline manager 61 (and the technology described herein can be, and in embodiments is, implemented using only a single packet iterator 63 and pipeline manager 61 as shown in FIG. 6), it will be appreciated that in general the shared packet pipeline 60 may be implemented using multiple packet iterators, and/or pipeline managers, which can be shared as appropriate between different pipeline stages. For example, a single pipeline manager 61 could provide packets for processing to multiple packet iterators 63, so long as any processing conflicts are appropriately handled. In the present embodiments, however, there is only a single packet iterator 63.

It will be appreciated in this respect that the packet iterator 63 is operable to process packets for any of the pipeline stages to be executed, and that the packet iterator 63 is essentially generic in that it operates to perform the same basic processing operations for packets that are received from any of the different pipeline stages, but in such a manner that different processing operations are performed, as appropriate, for the different pipeline stages.

In particular, as will be explained further below, the packet shading pipeline 60 will, when processing a packet for a particular one of the pipeline stages to be executed, trigger execution of the required compute shader for that pipeline stage, by issuing an appropriate request to the shading manager 47 specifying which computer shader is to be executed. The packet shading pipeline 60 will also perform, via the memory manager 49, any memory allocations/deallocations that should be performed as part of the processing of a packet for the pipeline stage being executed.

For the geometry packet pipeline 42 described above, it will be appreciated that the number of pipeline stages to be executed is generally configurable. Thus, the configuration of the geometry packet pipeline 42 may be defined by an appropriate set of configuration state, in the form of state vector 64, that stores information as to the current configuration of the packet shading pipeline 60.

The state vector 64 can thus indicate, for a given processing job, the number of pipeline stages to be executed. The state vector 64 may also include information as to the state that is to be used when executing those pipeline stages.

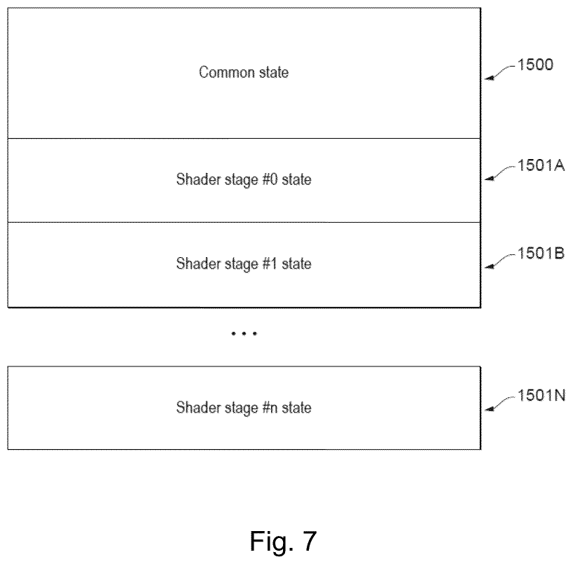

For example, as shown in FIG. 7, the state vector 64 may generally be used to store common state 1500 that is to be used by the geometry packet pipeline 42 as a whole. This common state 1500 may, for example, include viewport parameters, the configuration of memory pools for the different pipeline stages, and any other suitable state/parameters that may desirably be stored for the geometry packet pipeline 42 as a whole.

At least in the case where once the processing pipeline has been configured for an instance of execution there is then a fixed mapping between pipeline stages and the processing operations that those pipeline stages should perform (which may be considered as a ‘legacy’ mode operation, that may also be supported by the graphics processor in addition to the particular operation in the manner of the technology described herein), the state vector 64 could also store, for each pipeline stage, respective per-pipeline stage state information 1501A, 1501B, . . . , 1501N. An example of a layout for the state vector 64 in this legacy mode operation is shown in FIG. 7. The per-pipeline stage configuration state may for example define the type of pipeline stage (which will in turn define the shader program that is to be invoked for that pipeline stage), the workgroup size for that pipeline stage, the amount of expansion that is to be performed for packets, and any other suitable state/parameters that may desirably be stored for the respective pipeline stages within the packet shading pipeline 60 portion of the geometry packet pipeline 42, and this configuration state could then be used by the packet iterator 63 to control processing of packets according to the desired pipeline stage configuration, e.g. to trigger the appropriate compute shading, etc., to execute the pipeline stage.

That is, in order to implement the geometry packet pipeline 42 described above, there may be an initial configuration that configures the pipeline stages to perform certain processing operations based on that initial configuration (and this initial configuration may be performed in advance, e.g. prior to starting a first render pass). Subsequent state changes could then also be passed down the geometry packet pipeline 42 to update/set state as needed, e.g. between render passes, or even between draw calls within a render pass.

This can then provide increased flexibly, e.g. compared to an entirely fixed-function processing pipeline. However, in this case, the pipeline stages and processing operations performed by those pipeline stages may still be essentially static, i.e. until/unless the processing pipeline is re-configured.

Thus, whilst the approach described above provides various benefits, and as noted above is in embodiments still supported by the graphics processor as an alternative, ‘legacy’ mode operation, the present Applicant now further recognises that in order to support even more dynamic processing flows, such as so-called “work graph” programming models, a fixed partitioning of the state vector 64 into a set of per-pipeline stage state information 1501A, 1501B, . . . , 1501N as shown in FIG. 7 may not be appropriate, as the processing operations that are performed by respective pipeline stages may need to be determined dynamically, i.e. in use, and so greater flexibility may be desired in this regard.

The present embodiments thus relate particularly to graphics processor operation in which the graphics processor can flexibly support more dynamic processing flows, including, but not limited to, “work graph” programming models, and in particular where these more dynamic processing flows can be supported efficiently, in hardware, rather than doing this entirely in software, or placing restrictions on the application programmer.

For example, a “work graph” as described in the Direct3D 12 API specification is a directed graph representing a collection of “nodes”, wherein each node is able to invoke a respective processing operation.

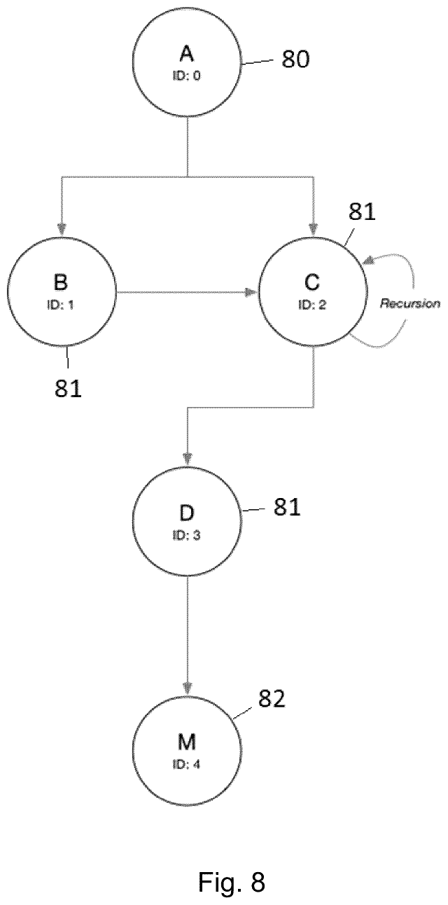

FIG. 8 thus shows a simple example of a work graph having a tree-like structure comprising an “entry” node A (with node ID: 0) at the top of the work graph, and which entry node A is connected to, and hence able to pass data to, either of nodes B (with node ID: 1) or C (with node ID: 2). In this example, node B is also able to pass data to node C, and node C can also pass data to itself. In this respect, it will be noted that described in the Direct3D 12 API specification, the work graph should be acyclic, except for possible self-recursion at a given node. Node C then passes data to node D (with node ID: 3) which in turn passes data to an “exit” node M (with node ID: 4) that terminates the work graph.

The particular processing operations that will be invoked by the respective nodes can be flexibly defined by the application programmer. For instance, and in this example, the exit node M may be configured to invoke a mesh shader, and in this case the other nodes within the work graph can effectively be considered to define a group of task shaders. Thus, in an example, the work graph may effectively replace the geometry packet pipeline 42 described above in that it will produce respective primitive packets on which the binning/tiling processing 13 can be performed, except that rather than there being a single task shader stage that can be invoked, for instance, the work graph itself is able to execute an arbitrary sequence of shader stages to dynamically produce all of the required geometry that will be input to the mesh shader.

Various arrangements would be possible in this regard and indeed an effect and benefit of the work graph processing model is to increase flexibility and facilitate the graphics processor to drive its own work.

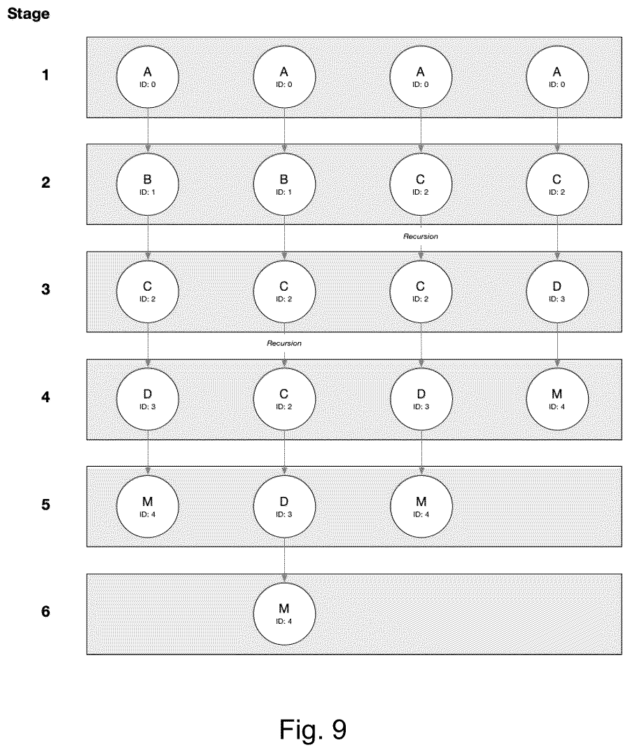

FIG. 9 shows a set of corresponding unique data flow paths through the work graph of FIG. 8. In this example, only a single level of recursion is permitted at node C, and so there are four unique paths through the work graph. As shown in FIG. 9, each of these unique paths can therefore be mapped to a sequence of processing stages, with each processing stage corresponding to a node at a particular depth level of the work graph. In the present embodiments, each processing stage can in turn be mapped to a pipeline stage for execution by the graphics processor, with that pipeline stage then being operable and configured to execute processing for any of the nodes (along any of the paths) at that depth level.

For instance, in this example, there is a single entry node, node A, at the top of the work graph. Thus, the first pipeline stage will always execute node A since each of the possible paths through the work graph starts in common with this same entry node (although it will be appreciated that in general this need not be the case, and a given work graph may have multiple entry nodes).

To execute the work graph, a suitable set of input data, i.e. an input record, will be provided to the entry node, in this case, node A. Typically, this initial input data will be stored in a software-controlled buffer, not shown in these figures, and provided from this buffer to the first pipeline stage, although other arrangements would be possible in this regard.

The first pipeline stage will then execute the entry node to process the input data and the result of this processing will be to produce a “packet” containing a corresponding set of one or more output records that have been produced by the execution of node A for a given set of input data and on which further processing is to be performed.

The processing of the input data by the first pipeline stage (i.e. the execution of the entry node) will also determine, for each output record that is produced, the next node that the output record is to be passed to for further processing. For instance, as shown in FIG. 8, in this particular example, the entry node A can then pass data to either node B or to node C, and which node a given output record will be passed to will be determined by the execution of node A.

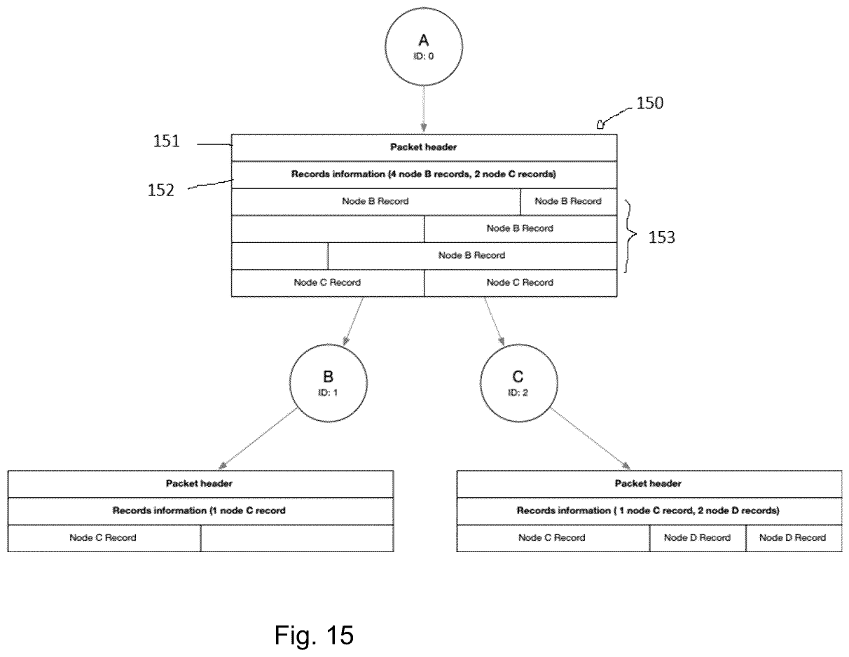

An example of this is shown in FIG. 15 wherein a particular execution of the entry node, node A, produces a “packet” 150 containing (data for) a set of six output records 153. In the example shown in FIG. 15, the packet 150 thus contains four records that are to be processed by node B and two records that are to be processed by node C, and the packet 150 contains appropriate records information 152 identifying which records are to be processed by which nodes. The packet 150 also contains a packet header 151 that can be used to identify and track the processing of the packet, as will be explained further below.

This packet 150 produced by the first pipeline stage can accordingly be passed to the second pipeline stage for processing and the second pipeline stage will then process the records within the packet. The second pipeline stage may then execute either node B or node C, and which node is executed will depend on the record that is being processed. Each execution of a node by the second pipeline stage to process a respective record may in turn produce a further packet containing a corresponding set of one or more output records that have been produced by the execution of that node.

This is also shown in FIG. 15 wherein the execution of node B by the second pipeline stage produces a packet containing (data for) an output record that is to be processed by node C, and the execution of node C by the second pipeline stage produces a packet containing (data for) a set of three output records, including one record that is to be processed by node C and two records that are to be processed by node D. These packets will in turn be passed to the next (third) pipeline stage for further processing, and as shown in FIG. 9, the third pipeline stage can execute either node C or D. Similarly, the fourth pipeline stage can execute any of nodes C, D or M, and so on.

In this example, referring back to FIG. 9, the longest path through the work graph contains six nodes, i.e. the sequence A-B-C-C-D-M, and so the maximum depth of the work graph is ‘six’.

This means that six pipeline stages will be needed to support this particular work graph (although depending on the paths that are followed, some data will not need to be processed by all of these pipeline stages).

It will be appreciated that this is merely one example and in general a work graph may have any suitable number and arrangement of nodes, subject to the Direct3D 12 API specification currently limiting the maximum depth of a work graph to 32 nodes. Thus, although in the example work graph shown in FIG. 8 there is only a single “entry” node and a single “exit” node, in general a work graph could have multiple entry nodes, and in that case the first pipeline stage may execute any of those entry nodes, and could also have multiple “exit” nodes that terminate the work graph.

A given node may invoke any suitable and desired processing operations but in general this will involve invoking a respective shader program. The nodes are thus effectively the building blocks out of which a system of dynamic execution flow can be constructed.

Various options possible in this regard.

For example, as alluded to above, respective nodes within the work graph may generally be operable to invoke respective shader programs.

A (and each) node within a given work graph may thus have an associated shader program indicator identifying the particular shader program that is to be invoked when executing that node (and the particular shader program may for example be identified relative to an appropriate shader resource binding table).

A given node that is operable to invoke a compute shader may also be operable to launch that compute shader in different ways.

For example, a given work graph may generally support different ‘types’ of nodes, that may include one or more of the following node types (and other node types may also be possible):
broadcasting launch nodes—operable to launch a batch (grid) of compute shader thread groups that all share a given input record, wherein the dispatch grid size can either be defined by the input record or fixed for the node, and wherein the thread group is fixed by the compute shader program (these are therefore similar to traditional compute shaders);
coalescing launch nodes—operable to launch a batch (grid) of compute shader thread groups that can process different input records, with no dispatch thread, wherein the compute shader declares a thread group size and the maximum number of input records a thread group can handle (the graphics processor will then attempt to fill that quote with each thread group launch, but does not have to, and can launch with fewer input records if desired);
thread launch nodes—operable to invoke (only) one thread for each input, so wherein the thread group size is fixed (1,1,1), and wherein the number of input records a thread group can handle is fixed to 1 (thread launch nodes thus allow multiple threads from different launches to be packed into a ‘wave’, but these threads will not share any processing resources).

A work graph may also contain other types of “program” nodes that are operable to invoke another instance of processing.

For instance, and as is the case in the example shown in FIG. 8, a work graph may include one or more ‘mesh’ nodes that are operable to invoke a respective mesh shading program. These mesh nodes will typically be provided as ‘exit’ nodes, as shown in FIG. 8, so that the work graph effectively then acts as an extended sequence of task shaders that produce the work items on which the mesh shading program is to be executed. The output from the mesh nodes can then be provided into the graphics processing pipeline, e.g. for the rendering/fragment processing 14.

Various other arrangements and node types would however be possible, and a given node may generally invoke any suitable instance of processing, which may, for example, comprise launching another processing pipeline, and/or another work graph, as desired.

Thus, the respective nodes within a work graph may also have associated node ‘type’ identifiers defining the type of node in question, and this node ‘type’ will also determine the particular processing operations that are to be performed when executing the nodes.

The node type identifier, together with the indication of the shader program to be invoked when executing that node, etc., thus defines a set of “configuration information” associated with the node in question and defining the particular processing operation that is to be performed when that node is to be executed. This configuration information can thus be, and is, used to control operation of the packet iterator 63 to perform the desired processing operations, for example by setting the appropriate context for the shader programs that are to be invoked to execute the different nodes within the work graph.

In this respect, it will be appreciated that as discussed above, each pipeline stage may need to execute multiple different nodes of the work graph, and will perform different processing operations when executing these nodes.

Further, which node is to be executed for a particular record may be determined in use, by execution of the previous node.

In the present embodiments, this configuration information will be stored in a suitable node descriptor array in memory that is typically populated by the (software) driver for the graphics processor when compiling the work graph for execution, and which node descriptor array stores, for each node within the work graph, the relevant configuration information needed to execute the processing for that node.

In this respect, each node within the work graph will also have a respective unique node identifier (so, referring to FIG. 8, node A has the identifier ‘0’, etc.) that can be used to index into the node descriptor array so that the relevant configuration information to execute a node can be identified and loaded into the graphics processor for use by the packet iterator 63 as and when it is needed.

For instance, as described above, in the present embodiments, when the processing pipeline is to execute a work graph, each packet that is to be processed by a respective pipeline stage of the processing pipeline may thus contain one or more records to be processed, and the packet will include metadata that can be used to identify for each record which respective node is to be executed to process that record, and the corresponding node identifier can then be used to fetch the relevant configuration information needed to execute that node into the packet iterator 63 in order to process the record in question.

This configuration information can thus be used, to control operation of the packet iterator 63, similarly as described above in relation to FIG. 7, except that the configuration information is now stored and defined on a per-node basis, rather than a per-pipeline stage basis as was the case in FIG. 7. Thus, in the present embodiments, rather than each pipeline stage being configured to perform a particular same processing operation for all packets that are to be processed by that pipeline stage, and this being defined by respective per-pipeline stage configuration, a given same pipeline stage may perform different processing operations for different records within a given packet (or across different packets), with the particular processing operation that is performed being specified for the particular record to be processed.

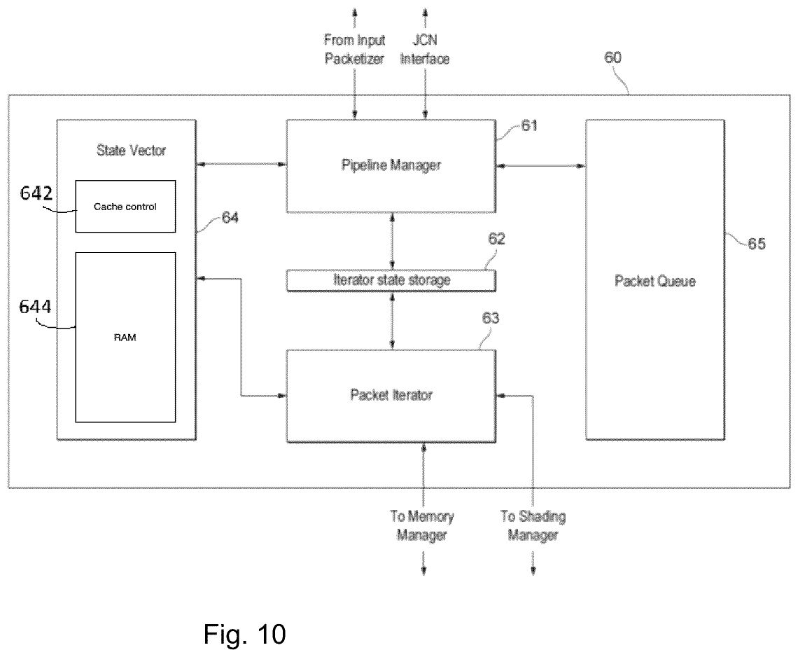

FIG. 10 shows in more detail the processing logic to execute the different pipeline stages within the packet shading pipeline 60 according to the present embodiments.

In this respect, the processing logic is generally the same as that shown in FIG. 6, and described above, except that the state vector 64 storage is effectively now a cache that provides an interface with an external memory in which the configuration information is stored, and via which interface the configuration information can be dynamically transferred into the graphics processor for use by the packet iterator 63 as and when that configuration information is needed.

For instance, as mentioned above, when executing a work graph, there will be a node descriptor array in memory that stores the relevant configuration information for the different nodes within the work graph.

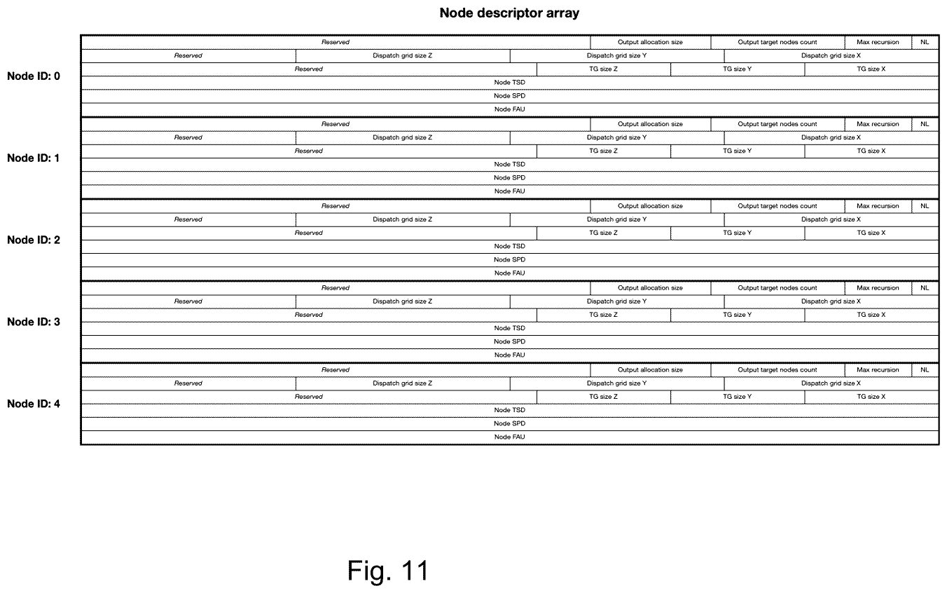

FIG. 11 thus shows an example of a node descriptor array according to an embodiment, in which there is stored respective configuration information for each of the five nodes for the work graph shown in FIG. 8. As discussed above, the configuration information stored for each node may comprise an indication of a respective shader program to be invoked when executing that node, as well as any other semantics defining the node ‘type’ and how the shader program is to be invoked, etc.. In this respect, in general, the configuration information stored for each node may include two main parts: what is needed for the packet iterator 63 and what is needed for the shader environment. Various arrangements would be possible in this regard.

This node descriptor array will thus be stored in external memory and populated during compilation of the work graph.

In use, when a pipeline stage is to execute a particular node to process a given record, the relevant configuration information for executing that node can thus be identified within the node descriptor array, so that it can then be loaded into the state vector 64 storage, as needed, and then provided from the state vector 64 storage to the packet iterator 63 to control operation of the packet iterator 63 accordingly.

Thus, as shown in FIG. 10, the state vector 64 storage comprises a RAM 644 that is operable to store respective configuration information, as well as a cache control unit 642 that is operable to control the transfer of configuration information from the external memory into the state vector 64 storage.

It will be appreciated that the state vector 64 storage may also (still) store at least some common state 1500 that is to be used by the processing pipeline as a whole. This common state 1500 may, for example, include viewport parameters, the configuration of memory pools for the different pipeline stages, and any other suitable state/parameters that may desirably be stored for the processing pipeline as a whole. However, rather than storing configuration information on a per-pipeline stage basis, with the RAM 644 being partitioned based on the number of pipeline stages to be executed (as shown in FIG. 7), the configuration information is instead dynamically cached within the RAM 644, so that the packet iterator 63 can perform lookups to the state vector 64 storage (e.g. based on the node identifiers) and obtain the relevant configuration information via the state vector 64 storage, either by the state vector 64 storage directly returning the relevant configuration information if it is already present within the RAM 644 (i.e. there is a cache ‘hit’), or by the cache control unit 642 causing the relevant configuration information to be fetched into the RAM 644 from its location in memory (and then provided to the packet iterator 63).

Thus, the present embodiments avoid fixed mapping and instead allow relevant configuration information to be loaded in dynamically as and when it is needed, as will be explained further below.

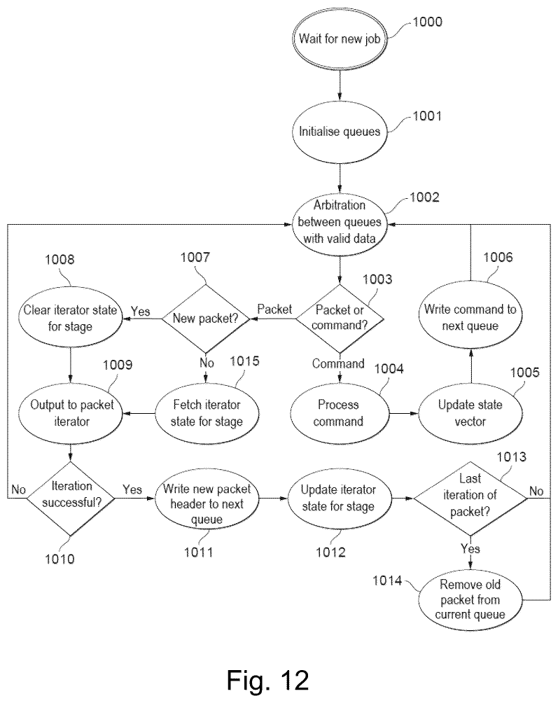

FIG. 12 is a flow chart illustrating the pipeline manager 61 operation according to the present embodiments. In FIG. 12, the pipeline manager 61 is responsible for configuring the shared packet queue 65 based on the number of pipeline stages to be supported. Thus, the pipeline manager 61 is operable to receive processing jobs via the job control network interface 50 (step 1000), and in response to receiving a new processing job, the pipeline manager 61 will then configure the shared packet queue 65 appropriately for the new processing job (step 1001).

Once the shared packet queue 65 is configured, the pipeline manager 61 will then start to select items for processing (step 1002).

In the work graph example above, the pipeline manager 61 will thus start by selecting an appropriate set of input data to be processed by the entry node at the top level of the work graph (i.e. node A), and this will be processed by the first pipeline stage of the processing pipeline.

This input record will then be processed accordingly to produce one or more output packets that will contain one or more records to be processed by a node at the next level of the work graph (so in the example above, these could be records either for node B or for node C). The packets output by the first pipeline stage will thus be added to the respective packet queue for the second pipeline stage. Similarly, any packets output by the second pipeline stage will be added to the respective packet queue for the third pipeline stage, and so on.

Over time, therefore, the respective packet queues for the different pipeline stages will be populated with packets of work, and the pipeline manager 61 when selecting a next item for processing may generally select that next item from the head of any of the packet queues/partitions within the shared packet queue 65, so long as those packet queues/partitions contain valid data. The pipeline manager 61 should therefore, and does, perform arbitration between the items from the input packetizer 43 and the head items from the various packet queues/partitions within the shared packet queue 65.

Any suitable and desired arbitration scheme may be used in this respect by the pipeline manager 61 to select which item(s) should be processed next, so long as progress can be made.

In the present embodiments, in addition to the packets that are processed, processing commands, e.g. to start a processing job, and/or to update some or all the state vector 64, may also processed by the same processing pipeline.

Thus, in the present embodiments, packets of work items to be processed and packets of state are both passed through the pipeline stages in a similar manner. This then allows state updates can be propagated through the pipeline stages to allow the graphics processing pipeline to be appropriately updated/re-configured for different instances of graphics processing pipeline execution.

Thus, when the pipeline manager 61 selects an item to be processed, this could either be a packet for which a pipeline stage is to be executed. Or, the next item could be a command that is to be propagated down the processing pipeline, e.g. to update some or all of the state vector 64 storage. If the item is such a command (step 1003—command), the command is then processed accordingly (step 1004) to update some or all of the state vector 64 storage (step 1005). The command is then written into the respective packet queue/partition for the next pipeline stage (step 1006), so that the command can be propagated through the pipeline, with the state vector 64 storage being incrementally updated as needed.

Various arrangements would be possible in this regard.

On the other hand, when the item is a packet (step 1003—packet), the pipeline manager 61 then checks whether this is a new packet (step 1007), or whether the packet is a packet that has already been partly processed. In this respect, it will be appreciated that a given pipeline stage may need to process a given packet multiple times. For example, where a packet contains plural records, each of these records may need to be separately processed. The packet iterator 63 that is used in the present embodiments is however restricted to only produce a single output packet at time. This, when a packet contains plural records, depending on the node type in question, the packet iterator 63 may only be able to process some of these in a particular processing cycle, such that the packet iterator 63 will need to process the same input packet multiple times to process all of the records within that input packet.

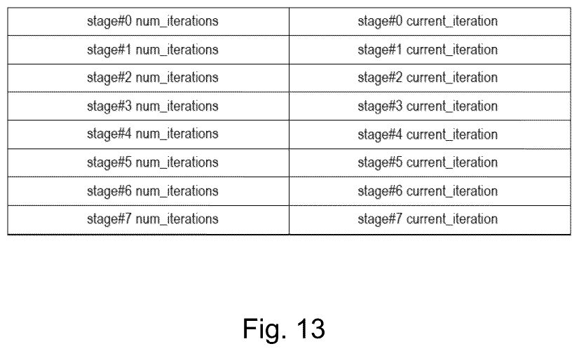

This is because the packet iterator 63 will not know in advance which processing is to be executed, and whether there will be sufficient free memory available to be allocated in a memory pool allocated to that pipeline stage for each of the potential output packets to be generated. Thus, rather than sending a single packet and having the packet iterator 63 try to manage this, if a same input packet contains multiple records that will each need to be (separately) processed, the pipeline manager 61 is operable and configured to issue that same input packet to the packet iterator 63 multiple times, as needed, to process all of the records within that input packet. This is tracked using iterator state 62, as will be explained further below. The iterator state 62 thus stores, for each pipeline stage, how far through the iteration for a particular packet the packet iterator 63 has progressed. This is shown in FIG. 13.

In particular, as shown in FIG. 13, it is tracked, for each pipeline stage that has been configured, the number of iterations that should be performed for each input packet (e.g. the number of output records that are to be produced, or equivalently the number of (sets of) records that are to be separately processed for that input packet), and it is also tracked, for the most recent packet that has been issued to the packet iterator 63 in respect of each pipeline stage, an indication of the current iteration, i.e. so that the iterator state 62 identifies how many iterations of the packet should be performed and how many have been done so far.

Thus, if the packet is a new packet (step 1007—yes), the iterator state 62 for the associated pipeline stage should be cleared (step 1008) (as this will be the first iteration of that packet), and the packet should then be output to the packet iterator 63 (step 1009). The packet iterator 63 will then process the packet, as will be discussed further below. So long as the iteration is successful (step 1010 yes), the packet header is then written to the respective packet queue/partition for the next pipeline stage (step 1011). The iterator state 62 is then updated to indicate that an iteration has been performed (step 1012). If this is the last iteration of the packet, i.e. such that the number of iterations performed is equal to the number of iterations that should be performed for the pipeline stage in question (step 1013 yes), the packet can then be removed from the respective packet queue/partition for the current pipeline stage (as its processing is now complete) (step 1014), and the pipeline manager 61 can then select a next packet for processing, which may be a packet from any packet queue/partition (i.e. in step 1002). On the other hand, if this is not the last iteration of the packet (step 1013—no), the packet should remain in the respective packet queue/partition for the current pipeline stage so that the packet will remain valid data that can accordingly be selected again by the pipeline manager 61 in step 1002 for its next iteration.

Correspondingly, if the packet is not a new packet (step 1007—no), the iterator state 62 should be fetched from storage (step 1015) before the packet is output to the packet iterator 63 so that if the iteration is successful (i.e. step 1010), the iterator state 62 can be updated accordingly (i.e. in step 1012).

If the iteration is not successful for any reason (step 1010—no), the operation finishes and the packet remains in the respective packet queue/partition for the current pipeline stage so that the pipeline manager 61 will subsequently select it again to re-try the iteration (i.e. the packet will remain valid data that can accordingly be selected again by the pipeline manager 61 in step 1002).

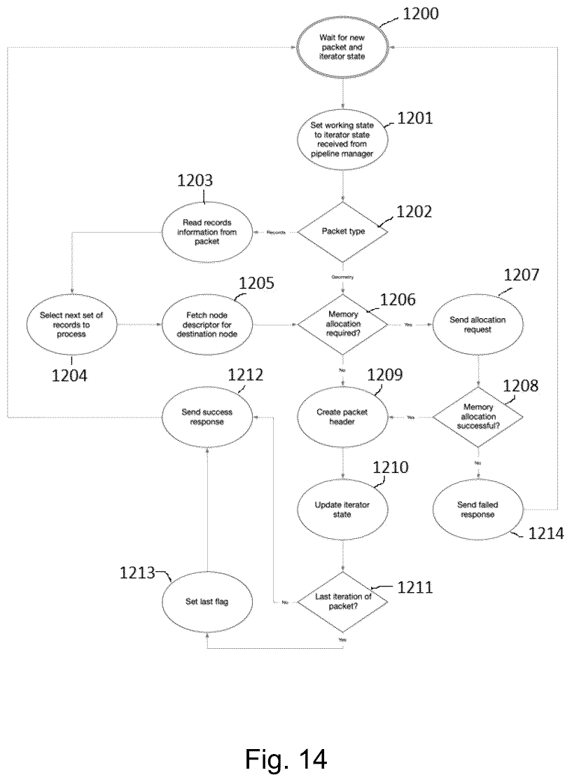

FIG. 14 illustrates the corresponding operation of the packet iterator 63 in response to receiving a packet from the pipeline manager 61 (i.e. in step 1009). Thus, the packet iterator 63 will wait to receive a new packet for processing (step 1200). The pipeline manager 61 when outputting a packet to the packet iterator 63 in embodiments will also provide the iterator state 62, as appropriate. The packet iterator 63 will thus set its working state based on the iterator state 62 received from the pipeline manager 61 (step 1201).

In embodiments, the graphics processor is able to support different types of processing pipeline. Thus, the packet shading pipeline 60 may be operable to execute more dynamic processing pipelines, for example to execute work graph programming models in which the processing operations that will be invoked by different pipeline stages are dynamically determined in use. In that case, the packets will contain records to be processed by respective nodes, as described above. The same packet shading pipeline 60 may however also be operable in a legacy mode to execute more ‘static’ processing pipelines such as the geometry packet pipeline 42 described above in relation to FIG. 5 in which once the processing pipeline has been configured there is then an essentially static mapping between pipeline stages and the processing operations that will be invoked by those pipeline stages.

Which type of pipeline is being executed could be signalled to the packet iterator 63 in any suitable and desired manner but in some embodiments the packet iterator 63 itself is able to identify from the packets it receives which type of processing pipeline is being executed.

Thus, a shown in FIG. 14, the packet iterator 63 may check the packet type (step 1202) to determine which type of processing pipeline is being executed, and depending on whether the packet is a ‘records’ packet or a ‘geometry’ packet then perform the appropriate processing of that packet.

For instance, in the case that the processing pipeline is executing a work graph, such that the packet contains a set of records to be processed by respective nodes of the work graph (e.g. as shown in FIG. 15), the packet iterator 63 will then read the records information from the packet (step 1203), and select a next set of records to process (step 1204). The packet iterator 63 will then fetch, via the state vector 64 storage, the node descriptor for the destination node (step 1205), so that the relevant configuration information to execute that node is loaded into the packet iterator 63.

The packet iterator 63 then performs the desired processing for the packet. In particular, if a memory allocation is required for storing an output packet that will be produced (step 1206—yes), the packet iterator 63 will trigger, via the memory manager 70, an appropriate memory allocation request (step 1207). So long as the memory allocation request is successful (step 1208—yes), the packet iterator 63 will then perform the desired packet processing, which in the present embodiments will include creating a header for the output packet (step 1209), and may further include triggering any required compute shading, via the shading manager 47, writing any output data to the allocated memory, issuing any memory deallocation requests, etc., depending on the processing to be performed for the particular pipeline stage that is being executed. Once the packet processing is finished (after step 1209), the packet iterator 63 updates its working state to indicate the iteration has completed (step 1210). This can then be signalled back to the pipeline manager 61 as part of the success response (step 1212) to allow the pipeline manager 61 to update the iterator state 62 (i.e. in step 1012).

The packet iterator 63 is also operable to determine whether this is the last iteration of the packet. If so (step 1211—yes), the packet iterator 63 sets an appropriate flag (step 1213) to indicate this. Again, this can be signalled back to the pipeline manager 61 as part of the success response (step 1212) to trigger the operations discussed above, i.e. in step 1013 of FIG. 11.

Thus, so long as the memory allocation is successful, the iteration is performed and an iteration success response is signalled to the pipeline manager 61 (step 1212). This then triggers the operations discussed above, i.e. responsive to step 1010 in FIG. 11. On the other hand, if the memory allocation is not successful (step 1208—no), an iteration failed response is sent (step 1214), and the packet will eventually be selected again for processing by the pipeline manager.

It will be appreciated that is the memory allocation for a packet is not successful, e.g. because there is no free memory in the memory pool assigned to that pipeline stage, depending on the arbitration scheme that is used by the pipeline manager 61, the pipeline manager 61 could select that packet again as the next packet, in which case the memory allocation will fail again. To avoid selecting the same packet again in this situation (which could potentially result in deadlocks if not managed appropriately), a respective flag may be used to indicate this (‘malloc_fail’), which flag can be stored in associated with the packets in the respective packet queues/partitions. Thus, if the memory allocation fails, the flag is set accordingly to indicate this, and this then prevents the pipeline manager 61 from selecting that packet for processing. The pipeline manager 61 will accordingly select another item, which should ensure continued progress can be made.

For instance, over time, as packets are processed and pass through the stages of the geometry packet pipeline 42, they may be temporarily allocated portions of memory within a respective memory pool or set of memory pools that is available to the geometry packet pipeline 42. When a given packet has been processed, and consumed, its allocated portion of memory can therefore be deallocated. Thus, at least some of the pipeline stages within the geometry packet pipeline 42, and particularly the last pipeline stage, is operable to trigger such memory deallocations, which are again handled by the memory manager 70.

The above described the processing for ‘records’ type packets. On the other hand, when the packet is a ‘geometry’ packet, e.g. and the processing pipeline is operating in ‘legacy’ mode, the packet processing to be performed, including the shader program to be invoked, etc., will be specified for the pipeline stage in question and in this case the state vector 64 storage is in embodiments arranged to store the respective configuration information on a per-pipeline stage basis, as shown in FIG. 7. This means that when the packet iterator 63 identifies that it is processing a ‘geometry’ packet, steps 1203-1204-1205 can be skipped, as the packet iterator 63 should in that case therefore simply use the configuration information stored for the pipeline stage in question.

Various other arrangements would be possible in this regard.

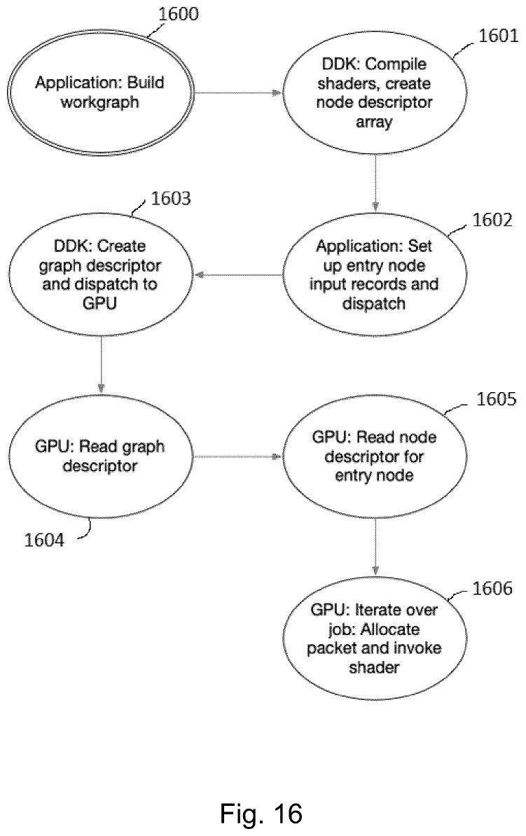

FIG. 16 shows schematically the overall processing flow to execute a work graph according to an embodiment. As shown in FIG. 16, the application will build a work graph (step 1600). The work graph will then be submitted to the graphics processor for execution, and the driver for the graphics processor will then compile the various shader programs, and create the node descriptor array, etc., needed to execute the work graph (step 1601). The application will set up the entry node input data and dispatch these for processing (step 1602). The driver for the graphics processor will accordingly create a graph descriptor and send this to the graphics processor (step 1603). When running the processing pipeline to execute the work graph, the graphics processor will then read the graph descriptor (step 1604), and will read the node descriptor for the entry node (step 1605) to load in the relevant configuration information to execute that node. The graphics processor will then proceed to iterate over the processing job, as described above, by allocating packets and invoking shaders, as needed (step 1606) to execute the work graph.

Thus, in the present embodiments, a set of shared processing circuitry is used to execute a logical sequence of pipeline stages, in which the processing operations that are invoked by different pipeline stages can be dynamically determined and specified, thus allowing the shared processing circuitry within the packet shading pipeline 60 to support and implement more dynamic processing flows, such as those based on work graph programming models.

Various arrangements would be possible in this regard. For example, an effect and benefit of the approach described above is that the application programmer has increased flexibility as to the how the processing pipeline is configured, and which data is passed between different pipeline stages. Thus, whilst various embodiments are described above in relation to certain processing flows, it will be appreciated that the processing pipeline that is executed may generally comprise any suitable and desired processing pipeline, with any desired processing being performed to produce a desired output, and the logical sequence of pipeline stages may, for example, comprise an essentially arbitrary sequence of (compute) shader stages to produce the output.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A graphics processor comprising:
one or more processing circuits to execute a sequence of pipeline stages for a processing pipeline, the one or more processing circuits including:
a set of work queues identifying packets to be processed by the respective pipeline stages, wherein a packet contains one or more work items on which processing is to be performed;
an iterator circuit to process packets; and
a pipeline manager operable to select packets from the set of work queues for processing by the iterator circuit,
wherein for a particular instance of executing the processing pipeline, the iterator circuit when performing processing for a given pipeline stage of the processing pipeline is operable to invoke various processing operations to process respective sets of one or more work items that are to be processed by that pipeline stage,
with the particular processing operation that is invoked by the iterator circuit for the pipeline stage to process a particular set of one or more work items being determined and specified for that particular set of work items itself.

2. The graphics processor of claim 1, wherein the graphics processor has access to a memory for storing a respective set of configuration information associated with a corresponding set of available processing operations that can be invoked by respective pipeline stages of the processing pipeline, and
wherein the iterator circuit, when processing a respective set of one or more work items within a packet is operable to:
obtain the relevant configuration information associated with the particular processing operations specified for the respective set of one or more work items from memory; and
use the configuration information to invoke the specified processing operations.

3. The graphics processor of claim 2, comprising storage that provides a cache for transferring configuration information between the memory in which it is stored and the iterator circuit.

4. The graphics processor of claim 1, wherein for a particular instance of executing the processing pipeline to execute a work graph containing a set of connected nodes, in which respective nodes of the work graph can invoke respective processing operations, and in which the work graph contains one or more paths of nodes along which data can be passed, and wherein a respective path contains a sequence of one or more nodes defining a corresponding one or more depth levels of the work graph, the pipeline stages of the processing pipeline are mapped to the respective depth levels of the work graph so that a given pipeline stage is operable to execute processing for multiple different nodes at its respective depth level of the work graph.

5. The graphics processor of claim 4, in which packets to be processed by the processing pipeline contain sets of one or more records to be processed, and wherein there is stored within a given packet associated metadata indicating for the respective records within the packet the respective nodes that are to be executed to process those records.

6. The graphics processor of claim 5, wherein the graphics processor has access to a memory for storing an array of node descriptors storing configuration information for respective nodes of the work graph, and wherein for a set of one or more records for which a particular node is to be executed, the graphics processor is operable to obtain the relevant configuration information for that particular node as stored in the array of node descriptors, and the iterator circuit is then operable to use the obtained configuration information to invoke a respective processing operation to execute that node.

7. The graphics processor of claim 6, comprising storage that provides a cache for transferring configuration information between the memory in which it is stored and the one or more processing circuits that execute the pipeline stages.

8. The graphics processor of claim 4, wherein respective nodes of the work graph are operable to invoke respective different shader programs, and wherein the iterator circuit when processing a set of work items for which a particular shader program is specified is operable to issue shading requests to a set of one or more programmable execution units of the graphics processor to cause the set of one or more programmable execution units to execute the particular specified shader program.

9. The graphics processor of claim 4, wherein the processing pipeline comprises a sequence of N or more pipeline stages, wherein N is the maximum depth of the work graph being executed, and wherein the graphics processor comprises a corresponding N or more work queues so that each pipeline stage has a respective work queue for identifying packets of work items to be processed for that pipeline stage.

10. A data processing system including:
a graphics processor as claimed in claim 1;
a memory for storing a respective set of configuration information associated with a corresponding set of available processing operations that can be invoked by respective pipeline stages of the processing pipeline; and
a host processor operable to issue work to the graphics processor to trigger execution of the processing pipeline,
the host processor configured to execute a driver for the graphics processor which driver is operable, when issuing work to the graphics processor that will trigger execution of the processing pipeline, to populate the respective set of configuration information in advance of the processing pipeline execution so that the relevant configuration information can be loaded into the graphics processor as needed during the processing pipeline execution.

11. A method of operating a graphics processor,
the graphics processor comprising:
one or more processing circuits to execute a sequence of pipeline stages for a processing pipeline, the one or more processing circuits including:
a set of work queues identifying packets to be processed by the respective pipeline stages, wherein a packet contains one or more work items on which processing is to be performed;
an iterator circuit to process packets; and
a pipeline manager operable to select packets from the set of work queues for processing by the iterator circuit,
wherein for a particular instance of executing the processing pipeline, the iterator circuit when performing processing for a given pipeline stage of the processing pipeline is operable to invoke various processing operations to process respective sets of one or more work items that are to be processed by that pipeline stage, and
the method comprising:
for a set of one or more work items within a packet that is to be processed for a respective pipeline stage of the processing pipeline, and for which a particular processing operation is specified to process that set of one or more work items:
the iterator circuit:
identifying the particular processing operation that is specified to be performed to process that set of one or more work items; and then
invoking the specified processing operation to process the set of one or more work items.

12. The method of claim 11, wherein the graphics processor has access to a memory for storing a respective set of configuration information associated with a corresponding set of available processing operations that can be invoked by respective pipeline stages of the processing pipeline, and
wherein the method comprises:
the iterator circuit, when processing a respective set of one or more work items within a packet:
obtaining the relevant configuration information associated with the particular processing operations specified for the respective set of one or more work items from memory; and
using the obtained configuration information to invoke the specified processing operations.

13. The method of claim 12, wherein the graphics processor comprises storage that provides a cache for transferring configuration information between the memory in which it is stored and the iterator circuit, and wherein the obtaining the relevant configuration information associated with the particular processing operations specified for the respective set of one or more work items from memory is performed via the cache.

14. The method of claim 11, wherein for a particular instance of executing the processing pipeline to execute a work graph containing a set of connected nodes, in which respective nodes of the work graph can invoke respective processing operations, and in which the work graph contains one or more paths of nodes along which data can be passed, and wherein a respective path contains a sequence of one or more nodes defining a corresponding one or more depth levels of the work graph, the pipeline stages of the processing pipeline are mapped to the respective depth levels of the work graph so that a given pipeline stage is operable to execute processing for multiple different nodes at its respective depth level of the work graph.

15. The method of claim 14, in which packets to be processed by the processing pipeline contain sets of one or more records to be processed, and wherein there is stored within a given packet associated metadata indicating for the respective records within the packet the respective nodes that are to be executed to process those records, the method comprising:
using the metadata associated with a record to identify the particular processing operation that is to be performed to process that record.

16. The method of claim 15, wherein the graphics processor has access to a memory for storing an array of node descriptors storing configuration information for respective nodes of the work graph, and wherein for a set of one or more records for which a particular node is to be executed, the method comprises:
obtaining the relevant configuration information for that particular node as stored in the array of node descriptors; and
the iterator circuit using the obtained configuration information to invoke a respective processing operation to execute that node.

17. The method of claim 16, comprising storage that provides a cache for transferring configuration information between the memory in which it is stored and the one or more processing circuits that execute the pipeline stages, and wherein the step of obtaining the relevant configuration information for the node is performed via the cache.

18. The method of claim 14, wherein respective nodes of the work graph are operable to invoke respective different shader programs, and wherein the method comprises:
the iterator circuit when processing a set of work items for which a particular shader program is specified:
issuing shading requests to a set of one or more programmable execution units of the graphics processor to cause the set of one or more programmable execution units to execute the particular specified shader program.

19. The method of claim 14, wherein the processing pipeline comprises a sequence of N or more pipeline stages, wherein N is the maximum depth of the work graph being executed, and wherein the graphics processor comprises a corresponding N or more work queues so that each pipeline stage has a respective work queue for identifying packets of work items to be processed for that pipeline stage.

20. A non-transitory computer-readable medium storing instructions that when executed on one or more processor will cause the processor to perform a method as claimed in claim 11.
